(19) United States
(12) Patent Application Publication
(10) Pub. No.: US 2024/0163509 A1
(43) Pub. Date: May 16, 2024

(54) APPARATUS, METHOD AND COMPUTER PROGRAM PRODUCT FOR DISTRIBUTING VIDEO DATA OVER A NETWORK

(71) Applicant: Sony Group Corporation, Tokyo (JP)

(72) Inventors: Thomas KONINCKX, Stuttgart (DE); Erik CUMPS, Stuttgart (DE)

(73) Assignee: Sony Group Corporation, Tokyo (JP)

(21) Appl. No.: 18/280,954

(22) PCT Filed: Feb. 14, 2022
(86) PCT No.: PCT/EP2022/053488

§ 371 Date: Sep. 8, 2023

(30) Foreign Application Priority Data
Mar. 16, 2021 (EP) 21162766.6

(51) Int. Cl. H04N 21/4402; H04N 21/43

(52) U.S. Cl. CPC H04N 21/440281; H04N 21/43072

(57) ABSTRACT

Apparatus for a receiving device of a system for distributing video data over a network, the apparatus comprising circuitry configured to: acquire a signal from a video source configured for outputting video data over a first interface of the network; generate free running timing signals when the signal from the video source is acquired; produce a first video signal to be displayed at a second frame rate using the free running timing signals which have been generated.

### BACKGROUND

### Field of the Disclosure

The present invention relates to an apparatus, method and computer program product for distributing video data over a network.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

The performance of imaging devices has developed significantly in recent years. For example, imaging devices are now capable of capturing images of a scene with higher resolution and/or with higher frame rate than was previously possible. Moreover, imaging devices have found application in a wide range of different situations—including in medical settings and environments.

In some situations (such as during medical imaging in a medical environment) imaging devices must be used in order to provide a user with a substantially real time stream of the images which have been captured by an imaging device (i.e. a video stream). This may be required in a situation such as endoscopic surgery, whereby a doctor or surgeon can only view the surgical scene by viewing images from an imaging device (i.e. an endoscopic imaging device). While very high quality images from the imaging devices are desirable in these situations, rapid increases in the performance of the imaging device (such as increases in the resolution and/or frame rates of the imaging devices) have made it more difficult to perform live (i.e. substantially real time) streams of image data from the imaging devices.

In particular, any stream of image data (i.e. a video stream) which is used to provide substantially real time feedback of an action (e.g. display of images of an endoscopic tool on a display as a surgeon moves their hand) requires ultra low latency in the video visualisation. Latency in video visualisation leads to a delay in what the person sees on a display device (e.g. a monitor) compared to the actual state of the scene. This may lead to difficulties for a person in performing complex tasks when relying on streaming video from an imaging device, as the so-called ‘hand-eye coordination’ of the person relies on seeing the images from the imaging device in substantially real time. Moreover, in some situations, it may be necessary to switch a display from images captured by a first imaging device to images captured by a second imaging device. The video on the display device should be stable right after switching video sources—or on initial start-up of a new imaging device—to avoid disruption to the performance of the task. Any period of disruption in the display of video from the new imaging device (video source) will hinder the performance of the task.

Ultra low latency video transfer over Internet Protocol (IP) networks can be used in order to provide a substantially real time (low latency) video stream from an imaging device. However, ultra low latency video transfer over Internet Protocol IP networks requires the avoidance of buffering in the entire transfer path from video source to display. This is only possible if the refresh rate for displaying images on a display matches the framerate of the video source exactly; in other words, the video clock of the video source for must be reconstructed with extreme accuracy at the receiving end. The video input of the transmitter device needs to run at the same timing and frequency as the video output of the receiver device. If the transmitter device and the receiver device did not perform in this manner, the receiver would quickly have too much, or too little, data to output on the video link making the video link quickly unstable.

Since it may take a substantial amount of time before the video clock of the receiver has been synchronised with the video clock of the transmitter after switching the video source or after booting up of a video sources, it may also take a considerable amount of time before the new video can be displayed or displayed without disruption. Indeed, depending on the packet jitter on the network, it may take a considerable amount of time before the video clock is actually reconstructed. For as long as no video clock is available at the receiving end, no video can be displayed either.

As such, since a new video clock must be reconstructed every time a new input source is to be visualised, there may be a long period during which no video can be shown on display in systems which guarantee ultra low latency video display. This long period during which no images are visible might give the wrong impression to a user that customer's request to switch input sources was not recognised by the system, or that the system has become irresponsive, although this is a direct consequence of the requirement for ultra-low latency video transfer. Moreover, in certain situations—such as during medical imaging—a period during which no images are visible may reduce the ability of the surgeon to safely perform a task when relying on the images from an imaging device.

It is an aim of the present disclosure to address these issues.

### SUMMARY

In accordance with a first aspect of the present disclosure, an apparatus for a receiving device of a system for distributing video data over a network is provided, the apparatus comprising circuitry configured to: acquire a signal from a video source configured for outputting video data over a first interface of the network, the video data including native video data having a first frame rate and the signal indicating that the video source has been switched on; generate free running timing signals when the signal from the video source is acquired; produce a first video signal to be displayed at a second frame rate using the free running timing signals which have been generated, the first video signal to be displayed comprising initial image data for display before native video data is acquired from the video source; acquire native video data from the video source over the first interface; produce a second video signal to be displayed at the second frame rate using the free running timing signals which have been generated, the second video signal to be displayed comprising the native video data acquired from the video source; generate second timing signals after the signal from the first video source is acquired, the second timing signals being adjusted to lock with timing signals of the video source such that a frame rate of the receiving device synchronises with the first frame rate of the first video source; and produce a third video signal to be displayed at the first frame rate using the second timing signals, the third video signal to be displayed comprising the native video data acquired from the video source.

In accordance with a second aspect of the disclosure, an apparatus for a receiving device of a system for distributing video data over a network is provided, the apparatus comprising circuitry configured to: acquire a signal from a video source configured for outputting video data over a first interface of the network, the video data including native video data having a first frame rate and the signal indicating that the video source has been switched on; acquire first free running timing signals from the video source; produce a first video signal to be displayed at a second frame rate using the first free running timing signals received from the video source, the first video signal to be displayed comprising initial image data for display before native video data is acquired from the video source; acquire first native video data from the video source over the first interface, the first native video data from the video source being subject to a frame buffer by the video source; produce a second video signal to be displayed at the second frame rate using the free running timing signals received from the video source, the second video signal to be displayed comprising the first native video data acquired from the video source; acquire second native video data from the video source over the first interface, the second native video data from the video source not being subject to a frame buffer by the video source; generate second free running timing signals when the signal from the video source is received; produce a third video signal to be displayed at a third frame rate using the second free running timing signals which have been generated, the third video signal to be displayed comprising the second native video data acquired from the video source; generate second timing signals after the signal from the video source is received, the second timing signals being adjusted to lock with timing signals of the video source such that a frame rate of the receiver synchronises with the first frame rate of the video source; and produce a fourth video signal to be displayed at the first frame rate using the second timing signals, the fourth video signal to be displayed comprising the second native video data received from the video source.

In accordance with a third aspect of the disclosure, an apparatus for a video source of a system for distributing data over a network is provided, the apparatus comprising circuitry configured to: transmit a signal to a receiving device indicating that the video source has been switched on; generate first free running timing signals; transmit the first free running timing signals to the receiving device; transmit native video data of the video source to the receiving device, the native video data being subject to a frame buffer and having a first frame rate established by the first free running timing signals; switch to input timing signals of the video source; transmit native video data to the receiving device the native video data not being subject to a frame buffer and having a second frame rate established by the input timing signals of the video source.

In accordance with a fourth aspect of the disclosure, a method for a receiver side of a system for distributing video data over a network is provided, the method comprising the steps of: acquiring a signal from a video source configured for outputting video data over a first interface of the network, the video data including native video data having a first frame rate and the signal indicating that the video source has been switched on; generating free running timing signals when the signal from the video source is acquired; producing a first video signal to be displayed at a second frame rate using the free running timing signals which have been generated, the first video signal to be displayed comprising initial image data for display before native video data is acquired from the video source; acquiring native video data from the video source over the first interface; producing a second video signal to be displayed at the second frame rate using the free running timing signals which have been generated, the second video signal to be displayed comprising the native video data acquired from the video source; generating second timing signals after the signal from the first video source is acquired, the second timing signals being adjusted to lock with timing signals of the video source such that a frame rate of the receiving device synchronises with the first frame rate of the first video source; and producing a third video signal to be displayed at the first frame rate using the second timing signals, the third video signal to be displayed comprising the native video data acquired from the video source.

In accordance with a fifth aspect of the disclosure, a method for a receiver side of a system for distributing video data over a network is provided, the method comprising the steps of: acquiring a signal from a video source configured for outputting video data over a first interface of the network, the video data including native video data having a first frame rate and the signal indicating that the video source has been switched on; acquiring first free running timing signals from the video source; producing a first video signal to be displayed at a second frame rate using the first free running timing signals received from the video source, the first video signal to be displayed comprising initial image data for display before native video data is acquired from the video source; acquiring first native video data from the video source over the first interface, the first native video data from the video source being subject to a frame buffer by the video source; producing a second video signal to be displayed at the second frame rate using the free running timing signals received from the video source, the second video signal to be displayed comprising the first native video data acquired from the video source; acquiring second native video data from the video source over the first interface, the second native video data from the video source not being subject to a frame buffer by the video source; generating second free running timing signals when the signal from the video source is received; producing a third video signal to be displayed at a third frame rate using the second free running timing signals which have been generated, the third video signal to be displayed comprising the second native video data acquired from the video source; generating second timing signals after the signal from the video source is received, the second timing signals being adjusted to lock with timing signals of the video source such that a frame rate of the receiver synchronises with the first frame rate of the video source; and producing a fourth video signal to be displayed at the first frame rate using the second timing signals, the fourth video signal to be displayed comprising the second native video data received from the video source.

In accordance with a sixth aspect of the disclosure, a method of a video source side in a system for distributing data over a network is provided, the method comprising the steps of: transmitting a signal to a receiving device indicating that the video source has been switched on; generating first free running timing signals; transmitting the first free running timing signals to the receiving device; transmitting native video data of the video source to the receiving device, the native video data being subject to a frame buffer and having a first frame rate established by the first free running timing signals; switching to input timing signals of the video source; transmitting native video data to the receiving device the native video data not being subject to a frame buffer and having a second frame rate established by the input timing signals of the video source.

In accordance with a seventh aspect of the disclosure, an apparatus for a receiving device of a system for distributing video data over a network is provided, the apparatus comprising circuitry configured to: produce a first video signal to be displayed at a first frame rate using first timing signals, the first video signal to be displayed comprising native video data acquired from a first video source; acquire a signal from a second video source configured for outputting initial image data and second native video data over the network, the second native video data having a second frame rate and the signal indicating a switch to produce a video signal to be displayed using the second native video data from the second video source, wherein the initial image data comprises image data to be displayed before the native video data from the second video source is displayed; produce a second video signal to be displayed at a second frame rate, the second video signal to be displayed comprising initial image data acquired from the second video source; generate free running timing signals after the signal from the second video source is acquired, the free running timing signals being adjusted to lock with timing signals of the second video source such that a frame rate of the receiving device synchronises with the frame rate of the second video source; and produce a third video signal to be displayed at the frame rate of the second video source using the free running timing signals, the third video signal to be displayed comprising native video data acquired from the second video source.

In accordance with a eighth aspect of the disclosure, a method for a receiver side of a system for distributing video data over a network is provided, the method comprising the steps of: producing a first video signal to be displayed at a first frame rate using first timing signals, the first video signal to be displayed comprising native video data acquired from a first video source; acquiring a signal from a second video source configured for outputting initial image data and second native video data over the network, the second native video data having a second frame rate and the signal indicating a switch to produce a video signal to be displayed using the second native video data from the second video source, wherein the initial image data comprises image data to be displayed before the native video data from the second video source is displayed; producing a second video signal to be displayed at a second frame rate, the second video signal to be displayed comprising initial image data acquired from the second video source; generating free running timing signals after the signal from the second video source is acquired, the free running timing signals being adjusted to lock with timing signals of the second video source such that a frame rate of the receiving device synchronises with the frame rate of the second video source; and producing a third video signal to be displayed at the frame rate of the second video source using the free running timing signals, the third video signal to be displayed comprising native video data acquired from the second video source.

In accordance with a ninth aspect of the disclosure, a computer program product comprising instructions which, when the program is implemented by the computer, cause the computer to perform a method of the present disclosure is provided.

### Advantageous Effects

According to embodiments of the present disclosure, video can be displayed on a receiver side in a system for distributing video over a network even before a video clock of the transmitting device has been reconstructed on the receiver side. This facilitates the provision of video content when switching between video sources and when starting-up a new video source. As such, embodiments of the disclosure allow for subframe latency in video transfer (which is possible because the video clock of the video source is reconstructed at the receiving end for every new video source that is shown and/or booted up) while, at the same time, preventing blackout periods on monitors (or other forms of display devices) during the period where the new video clock is reconstructed. This provides a responsive low latency system for provision of video over a network and leads to a greatly improved user experience when switching on and/or switching between video sources.

Of course, it will be appreciated that the present disclosure is not particularly limited to these advantageous technical effects. Other advantageous technical effects will become apparent to the skilled person when reading the disclosure.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an example situation to which embodiments of the disclosure may be applied;

FIG. 2 illustrates an example system for distributing video data over a network;

FIG. 3 illustrates an example timing chart when switching video sources;

FIG. 4 illustrates an example system for distributing video data over a network;

FIG. 5 illustrates an example timing chart when switching video sources;

FIG. 6 illustrates an example system for distributing video data over a network;

FIG. 7 illustrates an example timing chart when starting-up a video source;

FIG. 8 illustrates an example system for distributing video data over a network;

FIG. 9 illustrates an example timing chart when starting-up a video source;

FIG. 10 illustrates an example system for distributing video data over a network in accordance with embodiments of the disclosure;

FIG. 11 illustrates an example timing chart when switching video sources in accordance with embodiments of the disclosure;

FIG. 12 illustrates an example system for distributing video data over a network in accordance with embodiments of the disclosure;

FIG. 13 illustrates an example timing chart when switching a video source in accordance with embodiments of the disclosure;

FIG. 14 illustrates an example configuration of an apparatus for a receiver side device in accordance with embodiments of the disclosure;

FIG. 15 illustrates an example system for distributing video data over a network in accordance with embodiments of the disclosure;

FIG. 16 illustrates an example timing chart when starting-up a video source in accordance with embodiments of the disclosure;

FIG. 17 illustrates an example system for distributing video data over a network in accordance with embodiments of the disclosure;

FIG. 18 illustrates an example timing chart when starting-up a video source in accordance with embodiments of the disclosure;

FIG. 19 illustrates an example timing chart when starting-up a video source in accordance with embodiments of the disclosure;

FIG. 20 illustrates an example timing chart when starting-up a video source in accordance with embodiments of the disclosure;

FIG. 21 illustrates an example method for a receiver side device in accordance with embodiments of the disclosure;

FIG. 22 illustrates an example configuration of an apparatus for a receiver side device in accordance with embodiments of the disclosure;

FIG. 23 illustrates an example configuration of a transmitter side device in accordance with embodiments of the disclosure;

FIG. 24 illustrates an example system for distributing video data over a network in accordance with embodiments of the disclosure;

FIG. 25 illustrates an example timing chart when starting-up a video source in accordance with embodiments of the disclosure;

FIG. 26 illustrates an example method for a receiver side device in accordance with embodiments of the disclosure;

FIG. 27 illustrates an example method for a transmitter side device in accordance with embodiments of the disclosure;

FIG. 28 illustrates an example configuration of an apparatus or device in accordance with embodiments of the disclosure.

### DESCRIPTION OF THE EMBODIMENTS

Referring now to the drawings, wherein like reference numerals designate identical or corresponding parts throughout the several views.

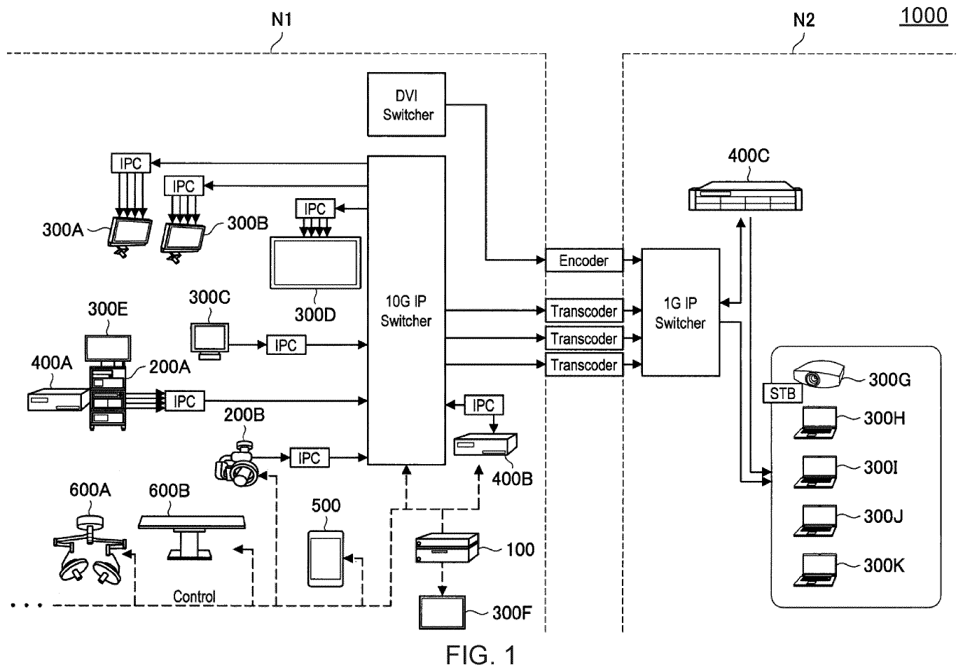

FIG. 1 illustrates an example situation to which embodiments of the disclosure may be applied. In particular, FIG. 1 is an explanatory diagram illustrating an example of a medical control system 1000.

Indeed, an example of a system in which an image signal which is made to conform to Internet Protocol (IP) is transmitted among apparatuses via an internet protocol converter (IPC), a switcher, an encoder, a transcoder, or the like is shown in FIG. 1. A “10G IP Switcher”, a “DVI Switcher” and a “1G IP Switcher” correspond to the switchers which can be used in order to switch between the input and output of a number of respective devices. Further, in FIG. 1, for example, an “Encoder” corresponds to the encoder, and, for example, a “Transcoder” corresponds to the transcoder. Note that, in the medical control system, it is also possible to employ a configuration where an image signal which is made to conform to IP is not transmitted.

Further, FIG. 1 illustrates an example where the medical control system 1000 includes a network N1 inside the operating room and a network N2 outside the operating room. Note that the medical control system 1000 may include, for example, only the network N1 inside the operating room.

The medical control system 1000 includes, for example, a medical control apparatus 100, input source apparatuses 200A, 200B, . . . , output destination apparatuses 300A, 300B, . . . , apparatuses 400A, 400B, . . . , each having functions of one or both of the input source and the output destination, a display target apparatus 500 at which various kinds of control screens are to be displayed, and other apparatuses 600A, 600B, . . . , each controlled by the medical control apparatus 100. The respective apparatuses are connected, for example, through wired communication of an arbitrary communication scheme or through wireless communication of an arbitrary communication scheme via an apparatus such as the IPC and the switcher.

Examples of the input source apparatuses 200A, 200B, . . . , can include medical equipment having an imaging function such as an endoscope (for example, the input source apparatus 200A) and an imaging device provided in the operating room, or the like, (for example, the input source apparatus 200B), for example, as illustrated in FIG. 1. In the following description, there is a case where the input source apparatuses 200A, 200B, . . . , will be collectively referred to as an “input source apparatus 200” or one of the input source apparatuses 200A, 200B, . . . , will be referred to as the “input source apparatus 200”.

Accordingly, the input source apparatuses 200A, 200B, . . . , are each configured to output medical video source information of a medical video of a medical procedure performed on a patient in an operating room (OR).

Examples of the output destination apparatuses 300A, 300B, . . . , can include, for example, a display device which can display an image. Examples of the display device can include, for example, a monitor provided in the operating room (for example, the output destination apparatuses 300A to 300F), an image projection apparatus such as a projector (for example, the output destination apparatus 300G), a monitor provided at the PC, or the like, (for example, the output destination apparatuses 300H to 300K) as illustrated in FIG. 1. In the following description, there is a case where the output destination apparatuses 300A, 300B, . . . , will be collectively referred to as an “output destination apparatus 300” or one of the output destination apparatuses 300A, 300B, . . . , will be referred to as the “output destination apparatus 300”.

Examples of the apparatuses 400A, 400B, . . . , each having functions of one or both of the input source and the output destination can include an apparatus having functions of one or both of a function of recording an image in a recording medium and a function of reproducing image data stored in the recording medium. Specifically, examples of the apparatuses 400A, 400B, . . . , each having functions of one or both of the input source and the output destination can include a recorder (for example, the apparatuses 400A and 400B) and a server (for example, the apparatus 400C), for example, as illustrated in FIG. 1. In the following description, there is a case where the apparatuses 400A, 400B, . . . . , each having functions of one or both of the input source and the output destination will be collectively referred to as an “apparatus 400” or one of the apparatuses 400A, 400B, . . . , each having functions of one or both of the input source and the output destination will be referred to as the “apparatus 400”.

The source-side IP converter converts the medical video source information (from the input source apparatuses) into packetized video data. This is then distributed across the IP network by a controller configured to control a network configuration and establish a connection between the source-side IP converter and the output-side IP converter (e.g. 10G IP switcher and 1G IP switcher in this example). The source-side IP converter is configured to provide the packetized data of the medical video in two video formats, where the two video formats include a first video format of the medical video at a first resolution, and a second video format of the medical video at a second resolution, the first resolution being different than the second resolution. The video data can then be displayed on a display target apparatus 500.

Examples of the display target apparatus 500 can include, for example, an arbitrary apparatus such as a tablet type apparatus, a computer such as a PC, a communication apparatus such as a smartphone. In FIG. 1, a tablet type apparatus including a touch panel is illustrated as the display target apparatus 500. Note that the medical control system 1000 may include a plurality of display target apparatuses. Further, in the medical control system 1000, for example, one of the medical control apparatus 100, the input source apparatus 200, the output destination apparatus 300 and the apparatus 400 may play a role of the display target apparatus.

Examples of other apparatuses 600A, 600B, . . . , can include a lighting apparatus at an operating table (other apparatus 600A), the operating table (other apparatus 600B), or the like, for example, as illustrated in FIG. 1. Note that the medical control apparatus 100 does not have to have a function of controlling the other apparatuses 600A, 600B.

As such, in the example of FIG. 1 of the present disclosure, an imaging device such as input source device 200B is configured to obtain image data (such as a video stream) which is provided to an display device on a receiver side—such as output destination apparatus 300A—over an IP network. Moreover, it will be appreciated that a number of different imaging devices may be provided, each of which is configured to obtain image data of the scene in different resolutions.

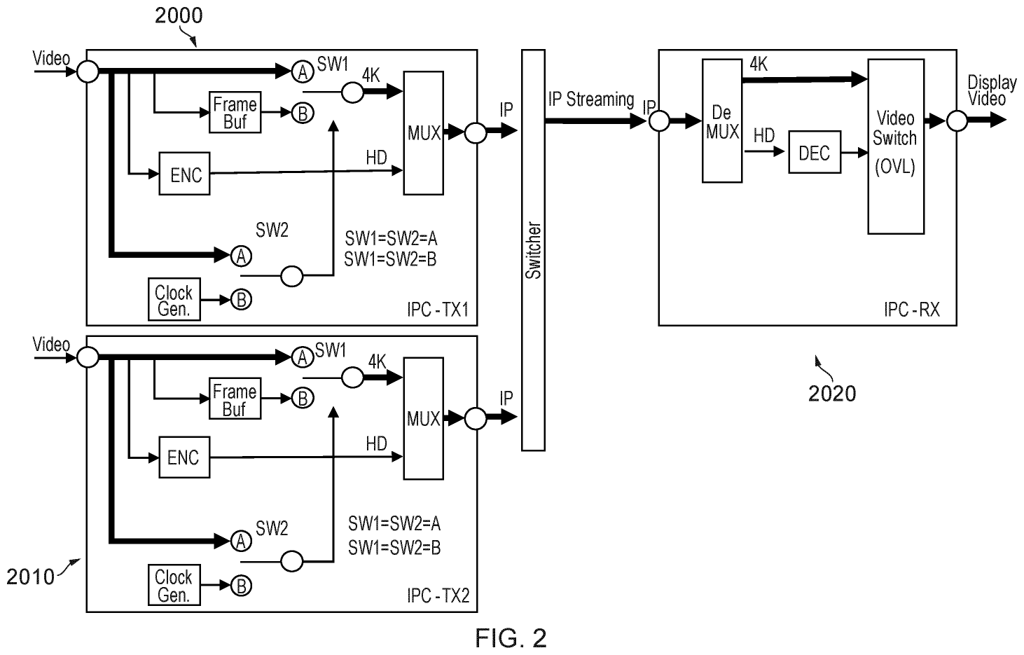

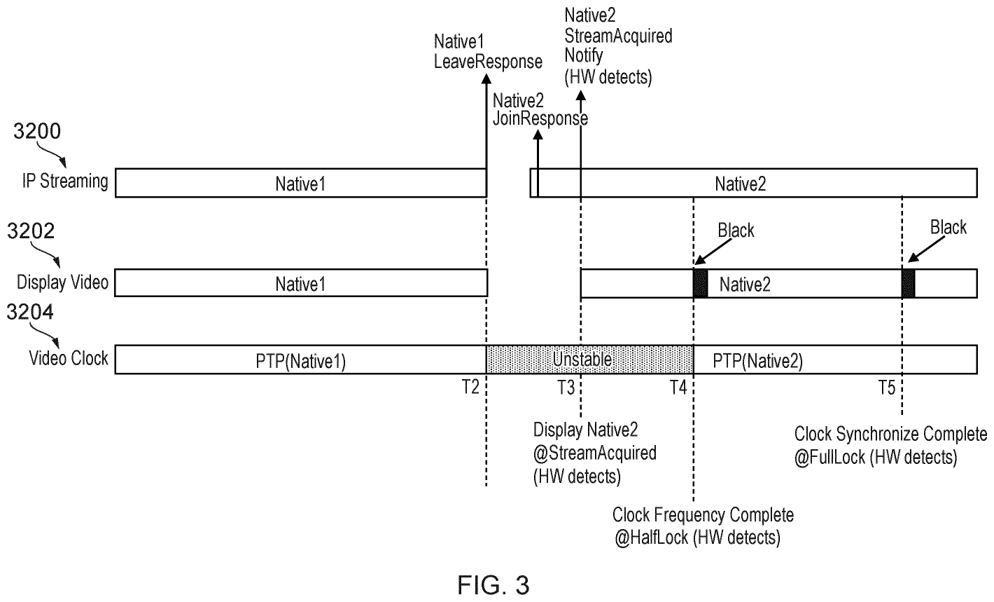

As described in the Background of the present disclosure, it is desired that the medical video on the medical display device should be stable right after switching medical video sources (i.e. without delay or disruption). However, since a new video clock must be reconstructed every time a new input source is to be visualised, there may be a long period during which no video can be shown on display in systems which guarantee ultra low latency video display. This long period during which no images are visible might give the wrong impression to a user that customer's request to switch input sources was not honoured, or that the system has become irresponsive, although this is a direct consequence of the requirement for ultra low latency video transfer. This problem will be explained in more detail with reference to FIGS. 2 and 3 of the present disclosure.

FIG. 2 of the present disclosure illustrates an example system for distributing video data over a network. In particular, FIG. 2 shows a receiving device and a number of transmitting devices which are part of a system for distributing data (such as video or video data) over a network in more detail than shown in FIG. 1 of the present disclosure.

Now, in FIG. 2, two transmitting devices 2000 and 2010 are connected to one receiver device 2020 via switcher. This enables the receiver device 2020 to switch between video received from the first transmitting device 2000 or the second transmitting device 2010. However, the number of transmitting and receiving devices are not particularly limited in this regard. There may be fewer devices in the system, or there may be considerably more devices in the system, depending on the situation to which the embodiments of the disclosure are applied.

When switching medical video sources from transmitting device 2000 to transmitting device 2002 (or vice-versa) there is a picture disturbance on a display device connected with the receiving device 2020. That is, in this example, the video source (i.e. video timings or video clock) of transmitting device 2000 and transmitting device are not synchronized (being video sources with different resolution and different frame rate), so a disturbance occurs on switching (owing to the lack of synchronization between the respective transmitting devices). Each transmitting device may be configured to receive video from a different imaging device (video source) having one or more different video characteristics. Therefore, a lack of synchronisation between the transmitting devices cannot generally be avoided. The disturbance to the video to be displayed (the “Display Video” in the example of FIG. 2) lasts until the receiver clock becomes stable after switching between the transmitting devices (i.e. until the video clock of the new transmitting device has been reconstructed on the receiver side by the receiver device). That is, while the vide clock of the receiving device is unstable (i.e. not synchronised with the clock on the transmitter side), the video on display is disturbed.

It will be appreciated that the manner in which the synchronization of the receiver side clock with the transmitter side clock is achieved, once the switch has occurred, is not particularly limited in accordance with embodiments of the disclosure. That is, synchronization of the receiver side clock with the transmitter side clock may be achieved from analysis of the timing stamps in the individual packets which are received from the transmitter side device, for example. The speed at which synchronization is achieved depends on several factors including the level of packet jitter on the network. More generally, therefore, the receiver may generate a new video clock which is then adjusted to lock (or synchronize) with the video clock of the transmitting device based on timing signals acquired from the transmitting device (with the timing signals being provided, for example, in the packets which are received over the network from the transmitting device).

As such, it will be appreciated that there may be a considerable time delay after switching before the receiver clock becomes synchronised with the transmitter clock (i.e. before the transmitter side clock is reconstructed on the receiver side). This time delay will occur, to some extent, regardless of the method which is used in order to achieve synchronization of the receiver clock with the transmitter clock once switching has occurred.

Turning now to FIG. 3, an example timing chart when switching video sources is illustrated. This timing chart is indicative of the timing of certain events when switching between video sources in a system such as that described with reference to FIG. 2 of the present disclosure, for example.

In this example illustrated in FIG. 3 of the present disclosure, three distinct portions are shown on the time chart: an IP streaming portion 3200, a Display Video portion 3202 and a Video Clock portion 3204. For each of these separate portions of the timing chart, the time increases from left to right along the x-axis. As such, these three portions of the time chart share the same time-axis. The IP streaming portion 3200 indicates, for a given time, the content which is being transferred over the IP network (corresponding to “IP Streaming” between the Switcher and the receiver device 2020 in FIG. 2 of the present disclosure). The Display Video portion 3202 indicates, for a given time, the content which is being produced for display by the receiver device (corresponding to “Display Video” as output by the receiver device 2020 in FIG. 2 of the present disclosure). Finally, the Video Clock portion 3204 indicates, for a given time, the state of the video clock of the receiver device (i.e. the video clock portion 3204 indicates whether the video clock of the receiver device is synchronised with the video clock of the transmitting device 2000 of FIG. 2 of the present disclosure, for example).

As noted above, the timing chart of FIG. 3 of the present disclosure is an example of a timing chart when the receiving device 2020 of FIG. 2 of the present disclosure switches from the display of video from a first transmitting device 2000 (transmitting video from a first video source (not shown) over the IP network at a first frame rate) to the display of video from a second transmitting device 2010 (transmitting video from a second video source (not shown) over the IP network at a second frame rate).

A number of specific instances of time are indicated on the time chart illustrated in FIG. 3 of the present disclosure (namely, instances of time T, T3, T4 and T5).

In this example, T2 is the time when the first video source is terminated at IP streaming portion 3200 and Display Video portion 3202. That is, the video which is transmitted from the first transmitting device 2000 is the “Native1” video. Prior to time T, this “Native1” video is received over the IP network by the receiving device 2020 and output as the Display Video 3202 with low latency. Low latency display of the video is possible prior to time T because the video clock of the receiving device 2020 is synchronised with the video clock of the transmitting device 2000. Specifically, the video clock used by the receiving device 2020 prior to time T is the PTP(Native1) video clock of the first transmitting device 2000 (which has already previously been reconstructed on the receiver side) as indicated in the Video Clock portion 3204 of FIG. 3. However, at U the first transmitting device 2000 stops transmitting the Native1 video over the IP network as the switch from the first transmitting device 2000 to the second transmitting device 2010 begins (in response to a request to switch video sources from a user). At the same time, the receiver device 2020 stops display of the Native1 video from the first transmitting device 2000 (as the Native1 video is no longer being acquired (or streamed) over the IP network).

The new video source (from the second transmitting device 2010) appears in IP streaming portion 3200 at the time when the second transmitting device 2010 begins to transmit video over the IP network (this is indicated by “Native 2 JoinResponse” in FIG. 3). Then, the receiving device 2020 begins to display video acquired from the second transmitting device 2010 (i.e. the Native2 video) at T3 timing. This is when the Native2 video stream is actually acquired by the receiving device 2020. As such, in the period between U and T3 no video is produced for display by the receiving device 2020. The screen of a display device showing the video produced for display by receiving device 2020 would therefore be blank during this time period.

Furthermore, during the period between time U to time T3, the video clock of the receiving device 2020 is unstable (since it is not yet synchronised between the receiving device 2020 and the second transmitting device 2010). In fact, even after the period T3 the video clock of the receiving device 2020 remains unstable and unsynchronised to the second transmitting device 2010. Therefore, the video which is displayed by the receiving device 2020 even after time T3 remains unstable and prone to visual disturbance. As such, in the period between T3 and T4 the video displayed by the receiving device 2020 remains unstable and disturbed. The display of a display device showing the video produced for display by receiving device 2020 would therefore be prone to a large number of visual blanks, glitches and other disturbances during this time period while the video clock remains unstable.

Then, at time T4, the frequency of video clock become stable as the receiving device 2020 begins to lock onto the video clock of the transmitting device. This is illustrated in FIG. 3 of the present disclosure by the video clock of the receiving device 2020 becoming the video clock PTP(Native2) at time T4—as the receiving device reconstructs the video clock of the second transmitting device 2010. Furthermore, both the phase and frequency of the video clock of the receiving device 2020 become stable at T5. At this stage, the switch is complete and the Native2 video of the second transmitting device 2010 (from the second video source) is both stable and displayed by the receiving device 2020 (with the video clock of the receiving device 2020 being fully synchronised with the video clock of the second transmitting device 2010).

However, even though the receiving device switches to the video clock of the second transmitting device 2010 at time T4 (when the frequency of the video clock becomes stable) it will be appreciated that an additional visual disturbance is seen in the video produced for display by the receiving device 2020 at times T4 and T5 (indicated by the blacked-out portion of the Display Video portion 3204 at times T4 and T5). That is, corrections in the video clock of the receiving device 2020 as it locks onto the frequency of the video clock of the transmitting device 2010 and the phase of the video clock of the transmitting device 2010 cause further visual disturbance in the video output for display.

In summary, therefore, the video produced for display by the receiving device 2020 between T and T4 is unstable (as the video clock of the receiving device 2020 is not synchronised with the video clock of the new transmitting device 2010). This causes disruption when switching between video sources (i.e. transmitting devices) in a video distribution system leading to decreased usability of the system.

In order to reduce the disturbance after switching video sources from a first transmitting device (i.e. a first video source) and a second transmitting device (i.e. a second video source) a method to use a free run clock at the transceiver side has been proposed. This requires a clock replacement from an original clock of the video to a free run clock at the transceiver side, coupled with a frame buffer, which reluctantly causes at least an additional frame of latency. Additional unnecessary latency is not suited to situations where low latency is a requirement (e.g. in situations such as medical imaging, where the surgeon relies on a low latency video of the surgical scene in order to perform complex tasks (such as a surgical operation)).

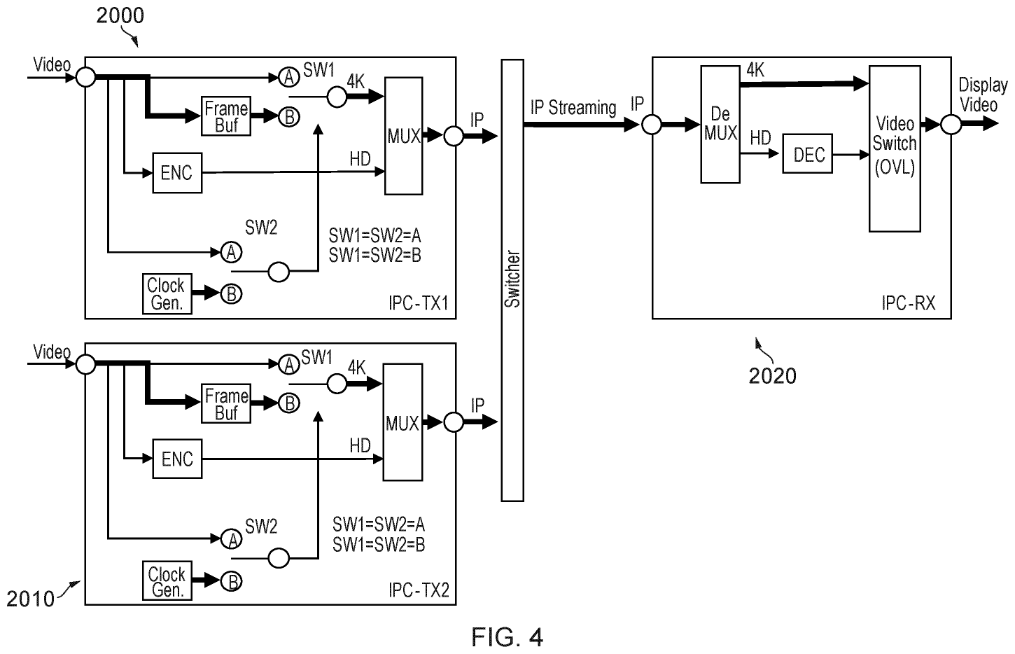

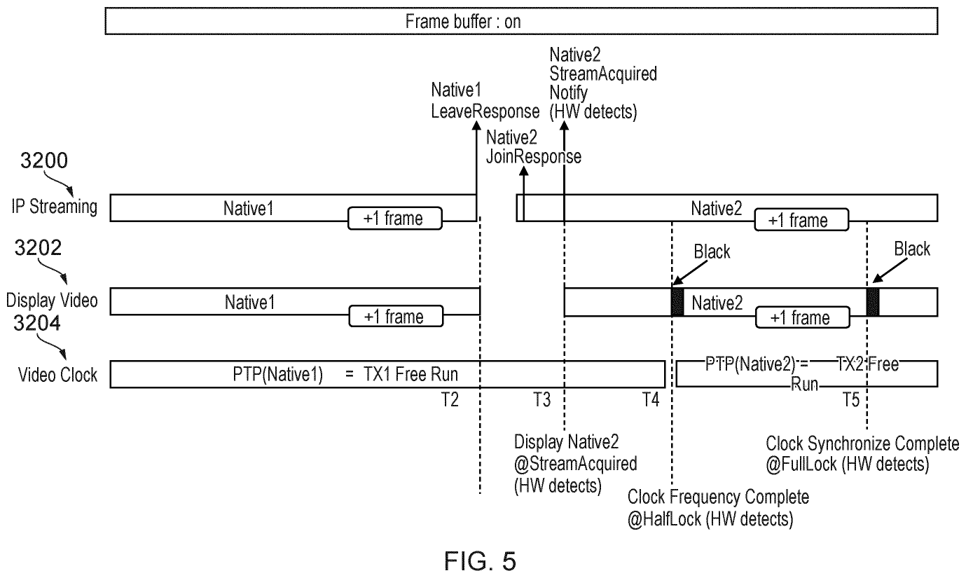

Consider the examples of FIGS. 4 and 5 of the present disclosure. Here, the first transmitting device 2000 and the second transmitting device 2010 use a free run clock TX1 free run and TX2 free run respectively. Furthermore, the first transmitting device 2000 and the second transmitting device 2010 use a frame buffer to add an at least one additional frame of latency.

Similar to the timing chart described with reference to FIG. 3 of the present disclosure, in FIG. 5 of the present disclosure, the first transmitting device 2000 stops transmitting the first video—Native1—at time T. The second transmitting device then begins to transmit the second video—Native2—over the IP network (indicated by “Native2 JoinResponse” in the example of FIG. 5 of the present disclosure). At time T3, the receiving device 2020 begins to produce the second video—Native2—for display. As such, during the time U and T3, no video is produced for display by the receiving device 2020.

However, during time U and T4 (i.e. before the receiving device 2020 locks onto the video clock TX2 of the second transmitting device 2010) the receiving device 2020 displays the second video—Native2—using the free run timing clock TX1 of the first transmitting device 2000. This avoids the unstable display period between time T and T4 as described with reference to FIG. 3 of the present disclosure. If the free run clock generated by the first transmitting device 2000 and the second transmitting device 2010 are synchronised (with a generator lock, for example), the disturbance after switching is reduced.

However, if the clock generator of the first and second transmitting device are not synchronized perfectly, some disturbance remains (i.e. between time T3 and T4 when using the free run clock TX1 of the first transmitting device 2000 to display the video from the second transmitting device 2010). Moreover, there is a period between U and T3 when no video is produced for display by the receiving device 2020. Additionally, as a frame buffer is permanently required (in order to drop or repeat a frame as necessary) owing to the use of the free running clocks on the transmitter side; yet use of the frame buffer adds at least an additional frame of latency. The increase in the latency is undesirable when switching between video sources in an environment which requires low latency video distribution and display.

As such, while a free run clock and frame buffer on the transmitter side, if completely synchronized (with a generator lock, for example), can reduce the visual disturbance on switching between video sources, it does not address the problems outlined in the Background of the present disclosure. Moreover, if the free running clock of the first transmitting device is not completely synchronized with the free running clock of the second transmitting device TX2, the reduction in the visual disturbance when switching from the first transmitting device to the second transmitting device (or vice-versa) will not be complete or effective.

Furthermore, it will be appreciated that the problems prohibiting the provision of responsive video in a low latency video distribution system, without disruption, is not confined to the situation of switching between video sources. Similar problems are encountered when a new video source is switched on (i.e. powered on, turned on or booted up) after a period of being switched off (i.e. powered off, turned off or the like).

Indeed, as explained with reference to FIG. 1 of the present disclosure, a wide variety of video sources—including endoscopes (such as medical endoscopes), cameras, PC output, vital instruments and the like—may individually be connected or connectable to a transmitting device (such as transmitting device 2000 as described with reference to FIG. 2 of the present disclosure). Each of these video sources (imaging devices) have individual characteristics such as frame frequency, picture resolution, clock jitter, booting time, and so on. Notably, a medical video source (such as a medical endoscope), has a comparatively long power on time and a comparatively large amount of clock jitter while booting. As such, when a user powers on a video source, the transmitting device cannot recognize the stable clock immediately and cannot therefore send IP streaming data over the network. This also causes disruption when turning on new video sources, as the user may be faced with a period where no video can be displayed from the new video source.

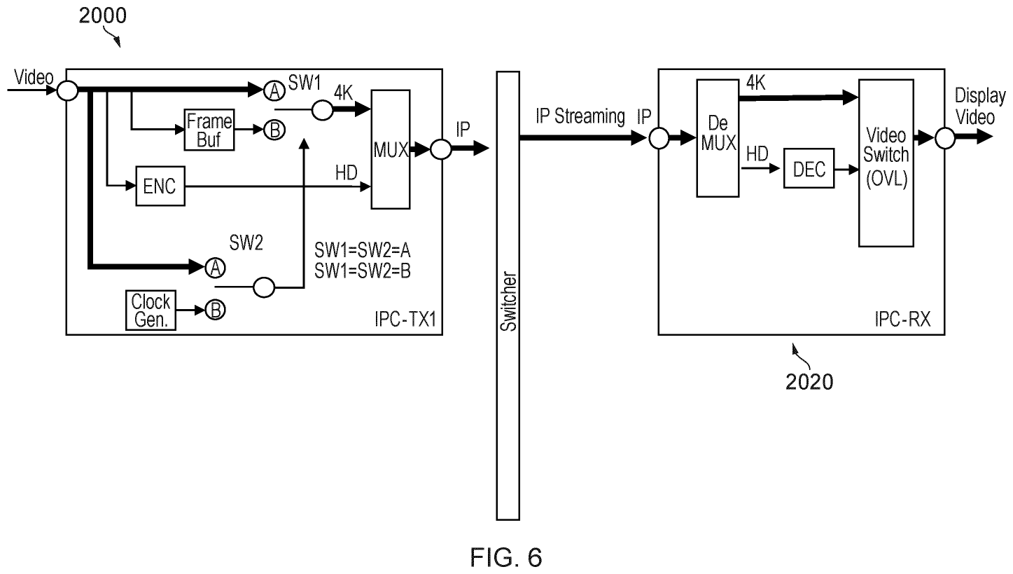

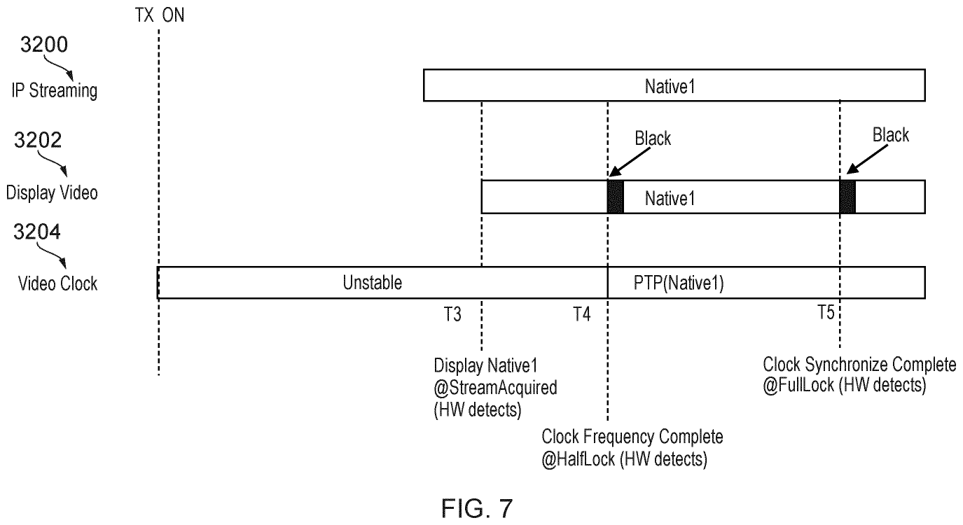

Consider now the example of FIGS. 6 and 7 of the present disclosure, where the problems when switching on a new video source are described in more detail.

Specifically, FIG. 6 of the present disclosure illustrates an example system for distributing video data over a network. Here, a single transmitting device 2000 is connected over the network (such as an IP network, for example) to a receiving device 2020. A number of different video sources (not shown) may be connected to this transmitting device 2020. Each of these video sources has a certain booting time, for example, during which there is clock jitter, before a stable video clock for the video source is established. As such, the transmitting device 2000 cannot recognise the stable clock of the video source immediately when the video source is switched on and cannot send IP streaming data (such as video data) to the receiving device 2020. As such, there is an unstable period when the video source is switched on during which no video data can be produced for display by the receiving device 2020. For a device (video source) for which the power on and power off are frequently operated (such as a medical video source during a medical operation) the amount of disturbance can become very significant.

FIG. 7 illustrates an example timing chart when starting-up a video source. This is an example of the timing of certain events when starting-up a video source in the system described with reference to FIG. 6 of the present disclosure. Indeed, the disturbance of the video data produced for display by the receiving device 2020 when switching-on a new video source can be understood in more detail from this example timing chart.

Similar to the timing charts in FIGS. 3 and 5 of the present disclosure, three distinct portions are illustrated (being an IP streaming portion 3200, a Display Video Portion 3202 and a Video Clock portion 3204). The video source (being an imaging device (such as a medical endoscope)) is initially turned off in this example. Then, at TX ON, the video source is switched on by the user.

Between time TX ON and T3, the video clock of the transmitting device 2000 is unstable (as it cannot immediately recognise the stable clock of the video source). During this time, no video data is transmitted over the IP network and no video is displayed by the receiving device. Then, once the transmitting device 2000 establishes the stable clock of the video source, the transmitting device 2000 can stream the video data—Native1—of the video source over the IP network. This video data is then produced for display by the receiving device 2020 at time T3. However, between time T3 and T4 of FIG. 7, the video clock of the receiving device remains unstable (as the receiving device has not yet synchronised with the video clock of the transmitting device). Therefore, even though video data is produced for display, the video data remains unstable and subject to visual disturbances. This makes it difficult for the user to rely on the video which is produced for display—particularly when performing complex tasks based on the video which is produced (during endoscopic surgery, for example).

At time T4, the receiving device 2020 achieves a frequency lock with the video clock of the transmitting device 2000. The video produced for display by the receiving device 2020 (corresponding to “Display Video” in FIG. 6 of the present disclosure) becomes more stable after time T4.

Nevertheless, further visual disturbances (the blacked-out portions of the Display Video in FIG. 7 of the present disclosure) occur immediately after time T4 and T5 as the video clock of the receiver device 2020 corrects to the video clock of the transmitting device 2000. Therefore, only a period of time after T5 does the display video produced by the receiving device 2020 for display become stable without glitches (i.e. visual disturbance).

Accordingly, a high level of disruption occurs when switching on a video source (or a transmitting device) in a video distribution system such as that illustrated in FIGS. 1 and 6 of the present disclosure.

In order to reduce the disturbance after switching on a video source, a method to use a free run clock at the transceiver side has been proposed. This requires clock replacement from an original clock of the video to a free run clock at the transmitter side, coupled with a frame buffer, which reluctantly causes at least an additional frame of latency. Additional latency is not generally suited to situations where low latency is a requirement (e.g. in situations such as medical imaging, where the surgeon relies on a low latency video of the surgical scene in order to perform complex tasks (such as during a surgical operation)).

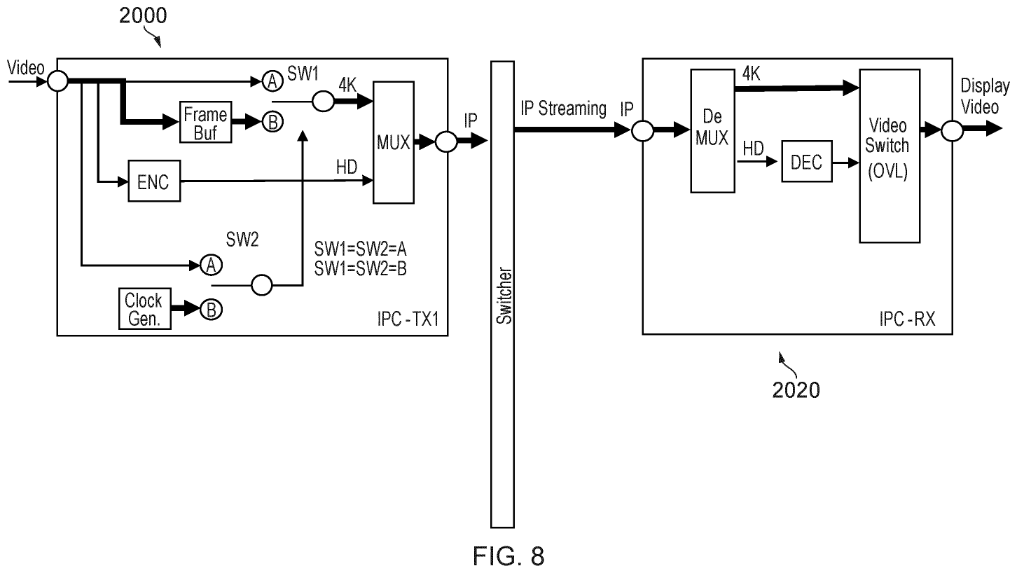

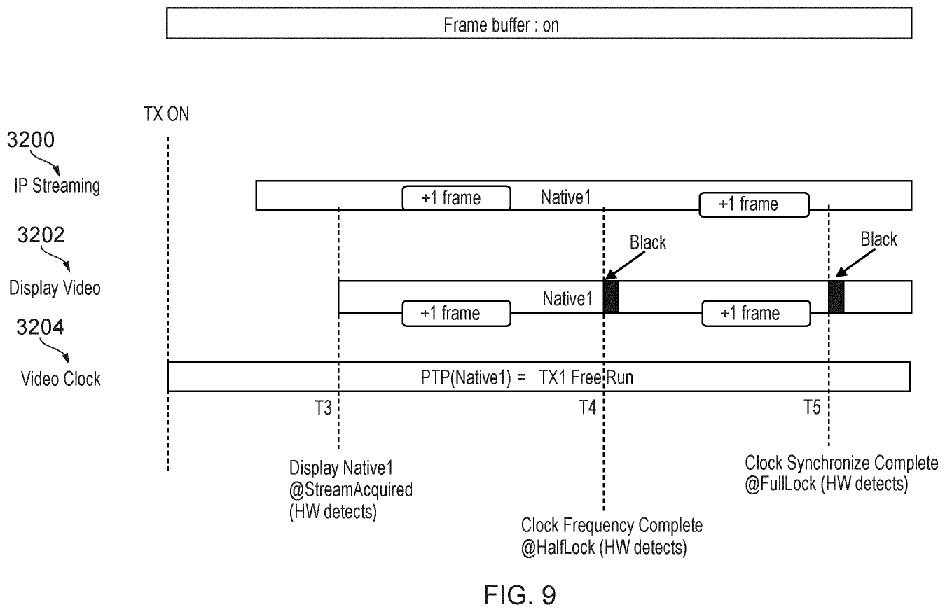

An example of a system using a free run clock on the transmitting side to reduce the disturbance after switching on a video source is illustrated with reference to FIGS. 8 and 9 of the present disclosure.

Specifically, FIG. 8 of the present disclosure illustrates an example system for distributing video data over a network.

Compared to FIG. 6 of the present disclosure, the transmitting device 2000 of FIG. 8 of the present disclosure differs by virtue of the fact that the video from the video source is subjected to a frame buffer and that the clock generator generates a free run clock. The video data transmitted across the IP network (IP streaming in FIG. 8) is therefore the video from the video source using a free run clock with a frame buffer.

Turning to FIG. 9 of the present disclosure (which illustrates an example chart when starting-up a video source—in a system such as that illustrated in FIG. 8 of the present disclosure), it can be seen that the use of the free run clock on the transmitter side reduces the amount of time after TX ON (the time when the user turns on the new video source) before the transmitting device can transmit the video data from the video source—Native1—over the IP network. This is because the transmitting device 2000 need not wait until the stable clock of the video source is recognised before the video is transmitted. This accelerates the provision of display video by the receiving device 2020 after the video source is switched on. The video which is produced by the receiving device 2020 for display is, however, unstable until the lock with the free run clock of the transmitting device is achieved at T4 and T5. Accordingly, a frame buffer is used in order to reduce the amount of visual disturbance. Nevertheless, the use of the frame buffer necessarily results in at least one additional frame of latency. Therefore, even though stability of the video produced for display can be achieved at an earlier time, the method of FIGS. 8 and 9 of the present disclosure increase the latency of the system. In other words, as the frame buffer must be used for the duration of the time in which the transmitting device uses the free running video clock (i.e. for duration of the display of the video) the cumulative cost to the latency of the system is very high. Moreover, there remains a time between TX ON (when the video source or the transmitting device is turned on) and T3 when no video data is produced for display by the receiving device 2020.

Accordingly, while a free run clock and frame buffer on the transmitter side can reduce the visual disturbance on switching on a video source, it does not alone address the problems outlined in the Background of the present disclosure.

As such, there remains a desire for an apparatus, method and computer program product which provide responsive low latency video with greatly improved user experience (including less visual disturbance) when switching on (or switching between) video sources in a system for distributing video over a network.

In order to address these issues, an apparatus for a receiving device and a transmitting device of a system for distributing video data over a network is provided in accordance with embodiments of the disclosure.

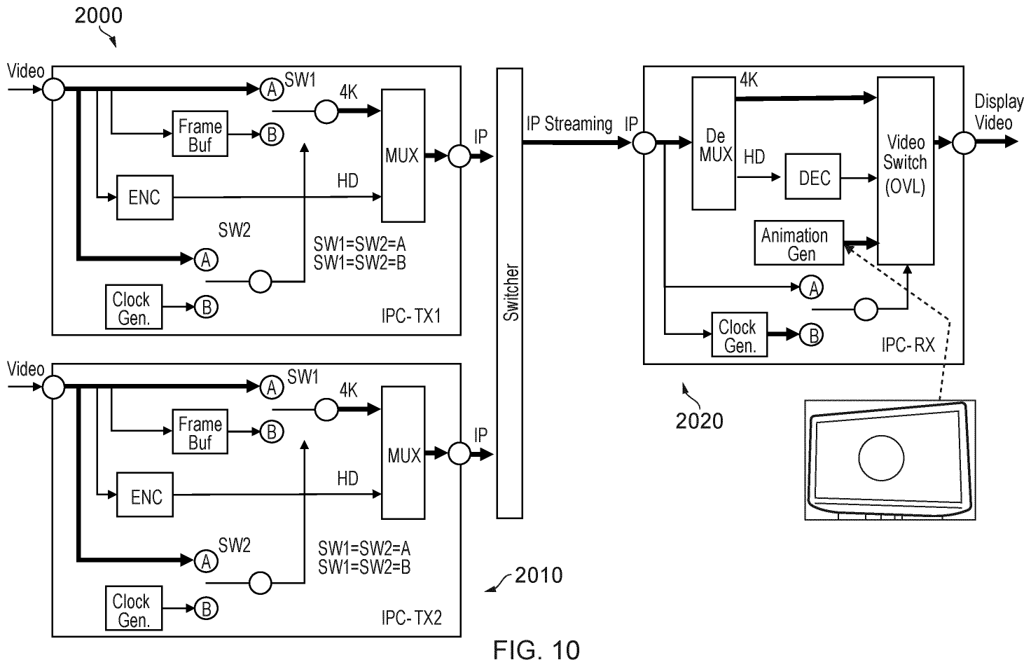

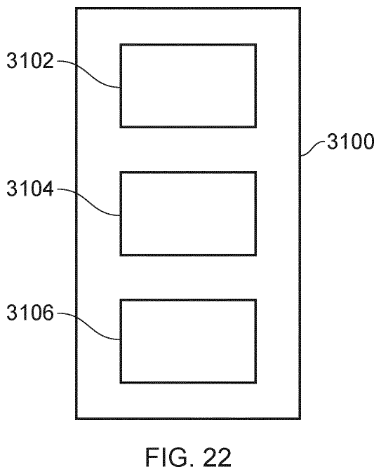

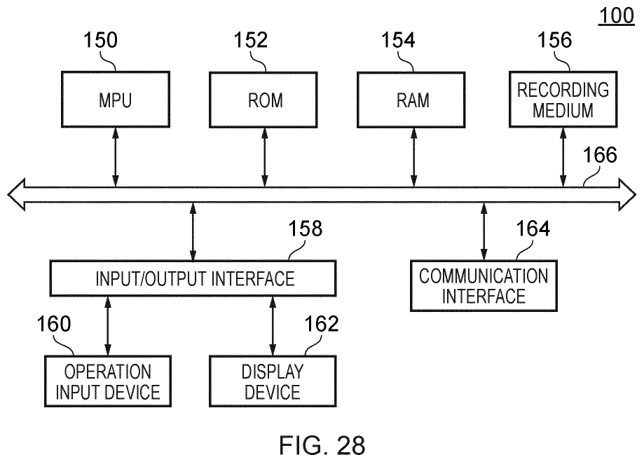

In the following, a first embodiment of the disclosure will be described with reference to FIGS. 10 to 21 of the present disclosure. Then, a second embodiment of the disclosure will be described with reference to FIGS. 22 to 27 of the present disclosure. An example hardware configuration of an apparatus or device in accordance with embodiments of the disclosure is then described with reference to FIG. 28 of the present disclosure.

### First Embodiment (Free Running RX)

As previously explained (with reference to FIGS. 3 and 7 of the present disclosure, for example), there is a period of time after switching between video sources and/or switching on a video source when the video clock of the transmitting device is being reconstructed by the receiving device. During this period, the receiving device does not produce stable video for display (and may even produce no video for display at all).

However, the inventors have realised that the use of a free-running video clock which is generated locally at the receiving side (e.g. in the receiving device) during the period where the video clock of the transmitting device (or video source) is being reconstructed by the receiving device allows an image and/or video to be produced for display. In this manner, stable video can be produced for display by the receiving device even during the transition period where a new video clock is being generated and synchronised to the video clock of the new transmitting device (or video source).

Consider, now, the example of FIG. 10 of the present disclosure. FIG. 10 illustrates an example system for distributing video data over a network in accordance with embodiments of the disclosure.

In this system, a first transmitting device 2000 and a second transmitting device 2010 are provided on the transmitting side of the network. Each of the first and second transmitting device receives video from a video source (not shown) which can be provided over an IP network, via a switcher, to a receiving device 2020. The video source from which the first transmitting device receives video is not necessarily the same video source as the video source from which the second transmitting device receives video. The receiving device 2020 can therefore display video from the first transmitting device 2000 and the second transmitting device 2020 depending upon which of the transmitting devices is chosen by the user.

Advantageously, the receiving device 2020 comprises a clock generator which generates a free run video clock on the receiver side. This free run clock on the receiver side can be used in accordance with embodiments of the disclosure when switching between the video from the first transmitting device 2000 and the second transmitting device 2010 in order to provide stable and responsive video for display.

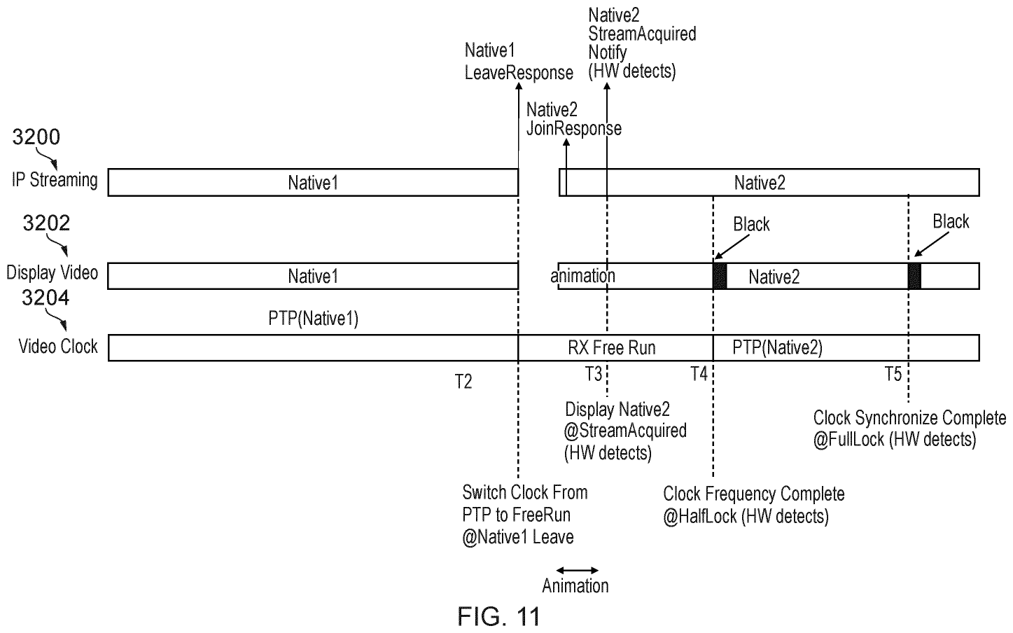

Consider now the example of FIG. 11 of the present disclosure. FIG. 11 illustrates an example timing chart when switching video sources in accordance with embodiments of the disclosure. This is an example of a timing chart as would be seen when switching between a video transmitted by the first transmitting device 2000 and the second transmitting device 2010 illustrated in FIG. 10 of the present disclosure, for example.

Prior to time T, the receiving device 2020 is receiving and displaying video—Native1—received from the first transmitting device 2000. That is, the Native1 video (from the first transmitting device 2000) occupies the IP Streaming portion 3200 and the Display Video portion 3202 of the timing chart prior to time U. Moreover, at this time (prior to U), the video clock of the receiving device is synchronised with the video clock of the transmitting device 2000 such that a video clock of PTP(Native1) is used by the receiving device 2020 for the display of the Native1 video from the transmitting device 2000. The PTP(Native1) video clock is fully synchronised with the video clock of the first transmitting device 2000 prior to the time T.

Then, at time U, a switch from the video transmitted by the first transmitting device 2000 to the video transmitted by the second transmitting device 2010 occurs. This may be in response to a request (via a user input device or the like) from the user to switch to video from a second video source supplying the second transmitting device, for example.

That is, at time T, the first transmitting device 2000 signals that a switch has been requested, and that it is stopping transmitting the video—Native1—over the IP network. This corresponds to “Native1 LeaveResponse” in the example of FIG. 11. Indeed, at the same time, the first transmitting device 2000 stops transmitting the video—Native1—over the IP network. Accordingly, the receiving device 2020 stops producing the video—Native1—for display.

However, according to embodiments of the disclosure, at this stage, the receiving device 2020 then switches from the video clock of the first transmitting device (i.e. PTP(Native1)) to a free running video clock RX generated locally on the receiver side (e.g. by the clock generator of the receiving device 2020 as illustrated in FIG. 10 of the present disclosure). The video clock of the receiving device 2020 does not, therefore, become unstable in the period between T2 and T4 (as illustrated in FIG. 3 of the present disclosure) as it is replaced with a free running video clock of the receiver device 2020. In other words, the free running video clock RX is used by the receiving device 2020 while the video clock of the new transmitting device (i.e. the second transmitting device 2010 as illustrated in FIG. 10 of the present disclosure) is being reconstructed on the receiver side.

Furthermore, a short time after U (even before the second transmitting device 2010 begins to transmit video over the IP network) the receiving device 2020 generates, locally, an animation (short image and/or video) which indicates that a switch has occurred (or, more generally, displays some other initial image and/or information to the user). This animation can be displayed by the receiving device 2020 using the free running clock RX which has been generated. The display of this animation (or other initial image or information) makes it obvious to the user that the request to switch input sources has been received and recognised, and that the system is preparing to show the requested new video (i.e. the video from the second transmitting device 2020).

The new video from second transmitting device 2010—Native2—then appears in the IP streaming (i.e. is transmitted over the IP network) at time T3; this corresponds to the time at which the second transmitting device 2010 begins to transmit the second video, Native2.

At this stage, the receiving device 2020 switches from the display of the animation to the display of the video—Native2—as received from the second transmitting device 2010. Video from the new video source is therefore produced for display to the user by the receiving device 2010.

However, in contrast to the example illustrated in FIG. 3 of the present disclosure, the video—Native2—from the second transmitting device 2010 is not transmitted using an unstable video clock (being the clock which is being reconstructed from the transmitting side device 2010). Rather, the receiving device 2020 of the present embodiment uses the free running video clock RX which has been generated locally on the receiving side in order to display the video from the second transmitting device after time T3. In fact, since the free running video clock is stable, the amount of visual disturbance in this period after T3 (before the video clock of the transmitting device is reconstructed) is reduced.

At time T4, the receiving device 2020 achieves reconstruction of the video clock of the second transmitting device 2010. That is, at time T4, the video clock of the receiving device 2020 locks onto the frequency of the video clock of the second transmitting device 2010. At this stage, the video clock of the receiving device 2020 switches from the free running video clock RX to the newly reconstructed video clock of the second transmitting device 2010. Accordingly, at time T4, the receiving device produces the video from the second transmitting device—Native2—for display using the reconstructed video clock of the second transmitting device 2010.

Then, at time T5, a full lock with the video clock of the second transmitting device 2010 is achieved (i.e. both a frequency and phase lock of the video clock).

Small visual glitches are observed at times T4 and T5 as the clock which is used by the receiving device 2020 corrects to the video clock of the second transmitting device 2010. Nevertheless, as a free run video clock RX generated on the receiver side is used between the periods T and T4, video can be displayed by the receiving device 2020 without disturbance during the transition between the first and second transmitting device 2000 and 2010 (i.e. during the time while the video clock of the receiving device synchronises with the video clock of the transmitting device). Moreover, use of the free run video clock on the receiver side enables initial video data (e.g. an animation) to be displayed even before the Native2 video is received from the second transmitting device. The amount of time while no display video is produced for display (i.e. the amount of time the user is presented with a blank screen) is significantly reduced.

Furthermore, advantageously—compared to the method of FIGS. 4 and 5 of the present disclosure (being a free running clock on the transmitter side)—use of a frame buffer is not required (as the video is displayed as it is received using the free running clock on the receiver side). Therefore, the reduction in the visual disturbance when switching between a first transmitting device 2000 and a second transmitting device 2010 can be achieved without increase in the latency of the system.

Accordingly, the embodiment of the disclosure described with references to the example of FIGS. 10 and 11 of the present disclosure allows for subframe latency in video transfer (which is possible because the video clock of the video source is reconstructed at the receiving end for every new video source that is shown) while, at the same time, preventing blackout periods on monitors which show the display video during the period where the new video clock (i.e. the video clock of the second transmitting device 2010) is reconstructed on the receiver side. This provides a responsive low latency system and leads to a greatly improved user experience when switching between video sources.

In addition, a free running video clock on the receiver side can also be used in situations where footage is streamed simultaneously in two qualities over the network by a transmitting device (or from the transmitting side). In an example system for distribution of video over a network, such as a system comprising the Tx IPC for example, a native video feed is used for ultra low latency display, while a proxy feed is a bandwidth optimized version of the same footage (i.e. the same video content is shown in both the native and proxy video feeds, with different video characteristics). The native video feed requires locked video clocks between the receiver side and the transmitter side in order to achieve the ultra low latency of display. The proxy video feed (which does not require a locked video clock) has a slightly increased latency compared to the native video feed. Nevertheless, as the proxy video feed does not require a locked video clock, it can be displayed before the video clock of the receiving device is locked to the video clock of the transmitting device (i.e. before the native video feed can be shown). Use of the free running clock on the receiver side (as according to embodiments of the disclosure) when switching between video sources in this situation is particularly advantageous.

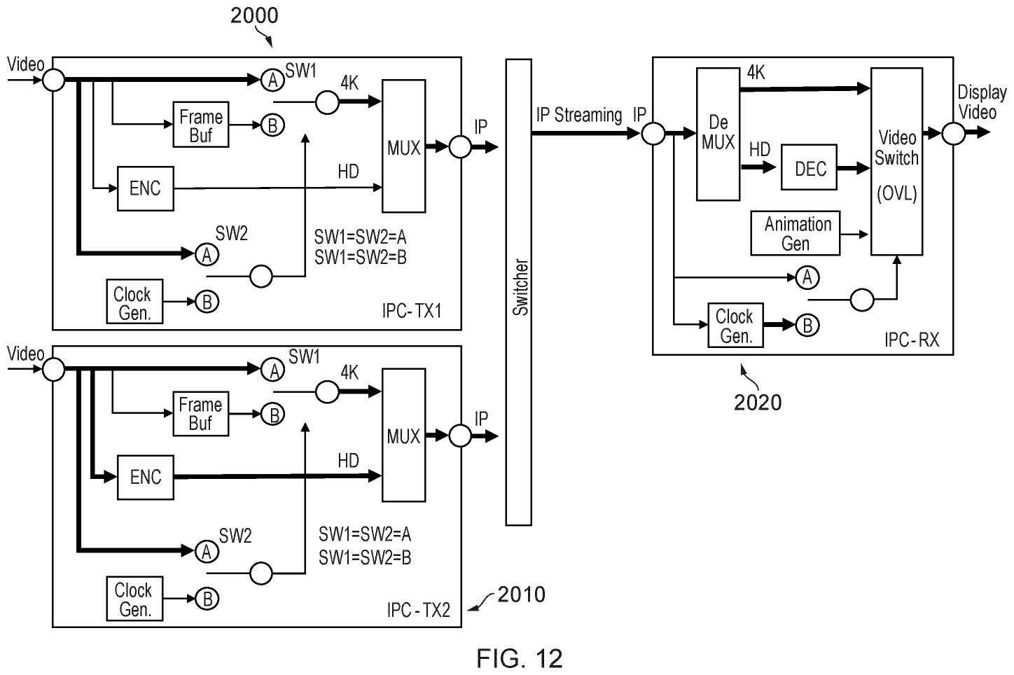

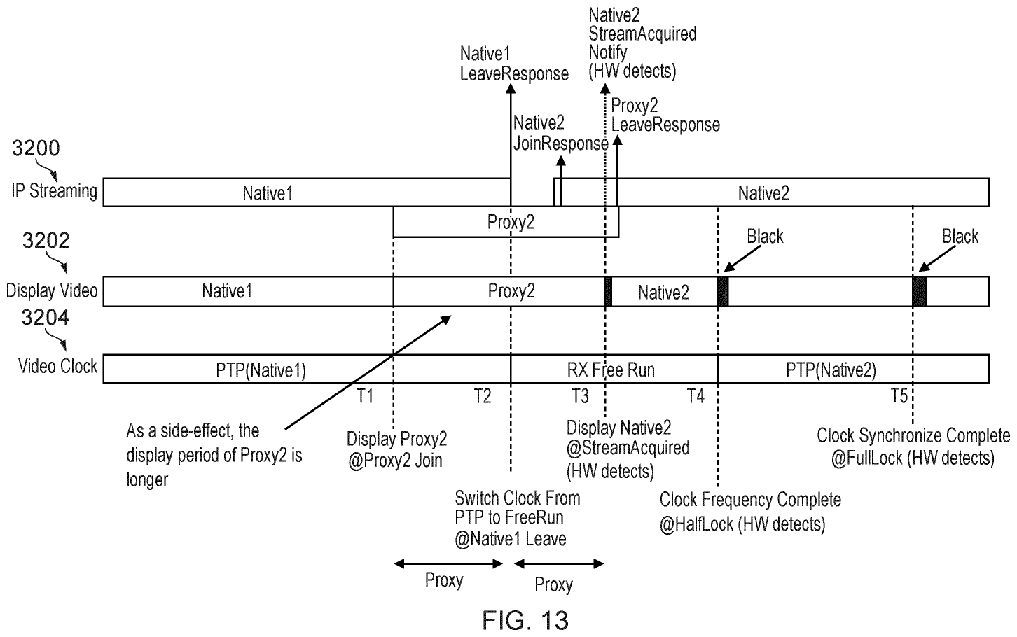

Consider, now, the examples of FIGS. 12 and 13 of the present disclosure.

In this example (as illustrated in FIG. 12 of the present disclosure), a first and second transmitting device 2000 and 2010 are shown on the transmitter side (which each receive video from a respective video source). Then, on the receiver side, a receiving device 2020 is shown which receives video over the IP network from one of the transmitting devices via the switcher. Each of the transmitting devices 2000 and 2010 are capable of transmitting footage in two qualities over the network at the same time; a first native video feed (for ultra low latency) and a second proxy video feed, which is a lower resolution bandwidth optimized version of the same footage.

The receiving device 2020 has a clock generator for generating a free running video clock locally on the receiver side during the period of time when the video clock of the transmitting device is being reconstructed. Optionally, the receiving device also contains an animation generator (similar to FIG. 11 of the present disclosure).

Turning to FIG. 13, an example timing chart when switching video sources in accordance with embodiments of the disclosure is illustrated.

In this example (as illustrated in FIG. 13 of the present disclosure) the receiving device 2020 first receives video—Native1—from the first transmitting device 2000. Accordingly, prior to time T1, the Native1 video is received from the IP streaming over the IP network and produced for display by the receiving device 2000 using the video clock PTP(Native1) which has been constructed from the video clock of the transmitting device 2010. The display of Native1 is stable at this time, because the video clock of the receiving device 2020 is locked to the video clock of the transmitting device 2000.

Then, at time T1, the second transmitting device 2010 begins to transmit the bandwidth optimized video feed (i.e. the proxy video feed)—Proxy2—over the IP network. That is, even before the first transmitting device 2000 stops transmitting the Native1 video data, the second transmitting device 2010 begins to transmit the optimized video feed-Proxy2; this may occur when a request to switch from the video from transmitting device 2000 to transmitting device 2010 has been received (following a user instruction, for example).

As soon as the second transmitting device 2010 begins to transmit the optimized video feed—Proxy2—the receiving device 2020 switches to producing video for display based on Proxy2. As such, at time T1, the Display Video portion 3202 of the time chart shown in FIG. 13 swaps to Proxy2, thus indicating that the Proxy2 video feed received from the second transmitting device 2010 is used, by receiving device 2020, to produce the video for display. A person watching a display screen displaying the video produced by receiving device 2020 for display (i.e. Display Video of FIG. 12 of the present disclosure) would therefore see the display switch from Native1 directly to Proxy2 at time T1. Indeed, because Native1 and Proxy2 are both simultaneously streamed across the IP network, there is no discontinuity between the display of the Native1 video feed from the first transmitting device 2000 and the Proxy2 video feed received from the second transmitting device 2010 when switching. Moreover, because the video feed Proxy2 is a bandwidth optimized video feed which does not require a locked video clock, the Proxy2 video feed can be displayed using the PTP(Native1) video clock (being a video clock on the receiver side locked to the video clock of the first transmitting device 2000) without disruption.

Then, at time T, the first transmitting device 2000 stops transmitting the Native1 video feed over the IP network (this can be seen from the IP streaming portion 3200 of FIG. 13). However, as the Native1 video feed from the first transmitting device 2000 is no longer used by the receiving device 2020 to produce the video for display, the fact that the first transmitting device 2000 stops transmitting the Native1 video feed does not cause any disruption to the display video which is produced by the receiving device 2020. Furthermore, at the same time, T, the receiving device 2020 switches from the video display clock PTP(Native1)—being the video clock synchronised to the first transmitting device 2000—to a free running video clock RX generated locally on the receiver side (e.g. by the receiving device 2020 as illustrated in FIG. 12 of the present disclosure). Moreover, because the Proxy2 video data does not require a locked video clock for display, the use of a free running video clock RX on the receiver side enables the Proxy2 video feed (from the second transmitting device 2010) to continue to be displayed without disruption.

At a time between T and T3 (indicated by “Native2 JoinResponse” in FIG. 13 of the present disclosure) the second transmitting device 2010 begins to transmit a second video feed—Native2—over the IP network. This second video feed—Native2—is transmitted by the second transmitting device 2010 simultaneously with the first video feed—Proxy2. Moreover, the Native2 video feed as transmitted by the second transmitting device contains the same visual content as the Proxy2 video feed. In other words, the Native2 video feed of the second transmitting device 2010 is used for ultra low latency display and requires locked video clocks, while the Proxy2 video feed is a bandwidth optimized version of the same footage (which does not require locked video clocks for display).

Once the Native2 video has been received by the receiving device 2020, the receiving device 2020 switches from displaying the Proxy2 video feed to the Native2 video feed acquired from the second transmitting device 2010. However, because the Proxy2 video feed is streamed simultaneously with the Native2 video feed, the receiving device 2020 switches the display video from the Proxy2 feed to the Native2 video feed without disruption (although a small visual glitch may occur owing to the change). Once the receiving device 2020 has switched to Native2 video feed, the transmitting device 2010 may stop transmitting the Proxy2 video feed over the IP network. As such, at time T3, the Native2 video stream from the second transmitting device 2010 is used by receiving device 2020, with the free running video clock RX, in order to produce the video for display.

In other words, according to embodiments of the disclosure, the receiving device 2020 generates a free run video clock RX locally on the receiver side. This free run video clock RX is used to display the Native2 video feed received from the second transmitting device 2010 even before the video clock of the receiving device has locked onto the video clock of the second transmitting device 2010. As such, since the free run video clock RX is a stable video clock, the Native2 video fee can be displayed in a time between T3 and T4 without disruption.

Then, at the time T4 illustrated in FIG. 13 of the present disclosure, the video clock of the receiving device 2020 locks onto the video clock of the second transmitting device 2010. That is, a frequency lock between the video clock on the receiver side and the video clock on the transmitting side is achieved. As such, at this time, the receiving device 2020 switches to displaying the Native2 video feed as received from the second transmitting device using the video clock PTP(Native2) which has been reconstructed from the video clock on the transmitter side (in accordance with timing signals received in the packets from the transmitting device, for example). Accordingly, at time T4, the receiving device 2020 produces the video from the second transmitting device 2010—Native2—for display using the reconstructed video clock PTP(Native2) of the second transmitting device 2010.

Finally, at time T5, a full lock with the video clock of the second transmitting device 2010 is achieved by the receiving device 2020 (i.e. both a frequency and phase lock of the video clock).

A small number of visual glitches (disturbances) are observed at times T4 and T5 as the video clock of the receiving device 2020 corrects to the video clock of the second transmitting device 2010 (from the free running video clock which had been generated on the receiver side, for example). Nevertheless, according to embodiments of the disclosure, the user can see video content (Proxy2) from the second transmitting device as soon as the request to switch from the first transmitting device 2000 to the second transmitting device 2010 is received. There is no discontinuity between the display of the Native1 video (from the first transmitting device 2000) and the Proxy2 video (from the second transmitting device 2010). The video feed Proxy2 is used only for a short time until the ultra low transfer latency video feed Native2 is received; indeed, owing to the use of the free running clock RX generated locally on the receiver side, the Native2 video feed can be displayed even before the video clock of the second transmitting device 2010 is reconstructed on the receiver side. The use of the Proxy2 video feed in this example, as opposed to an animation, allows video from the second transmitting device 2010 to be displayed as soon as the request to switch from the first transmitting device 2000 to the second transmitting device 2010 is received.

Accordingly, the embodiment of the disclosure described with reference to the example of FIGS. 12 and 13 of the present disclosure allows for subframe latency in video transfer (which is possible because the video clock of the video source is reconstructed at the receiving end for every new video source that is shown) while, at the same time, preventing blackout periods on monitors during the period where the new video clock is reconstructed on the receiver side. This provides a responsive low latency system and leads to a greatly improved user experience when switching between video sources.

While FIGS. 10 to 13 of the present disclosure have been described with reference to the example situation of switching between a first and second transmitting device, it will be appreciated that the present disclosure is not particularly limited in this regard. Indeed, according to embodiments of the disclosure, a free running clock on the receiving side (generated locally by the receiving device, for example) can be used in order to provide a responsive low latency system with greatly improved user experience when booting-up (or otherwise switching/powering on) a video source or transmitting device.

Hence, more generally, an apparatus for a received device 2020 of a system for distributing video data over a network is provided in accordance with embodiments of the disclosure.

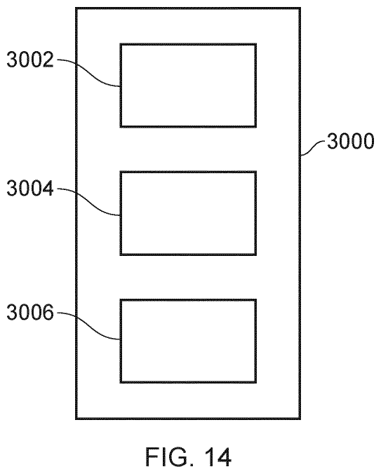

FIG. 14 of the disclosure illustrates an apparatus 3000 for a receiving device 2020 of a system for distributing video data over a network in accordance with embodiments of the disclosure. The apparatus 3000 comprises an acquiring unit 3002, a generating unit 3004 and a producing unit 3006.

In particular, the acquiring unit 3002 is configured to acquire a signal from a video source configured for outputting video data over a first interface of the network, the video data including native video data having a first frame rate and the signal indicating that the video source has been switched on. As such, the first frame rate is the frame rate of the input source (e.g. video source).

Then, the generating unit 3004 is configured to generate free running timing signals (first timing signals) when the signal from the video source is acquired, and the producing unit 3006 is configured to produce a first video signal to be displayed at a second frame rate using the free running timing signals which have been generated, the first video signal to be displayed comprising initial image data for display before native video data is acquired from the video source.

The acquiring unit 3002 is further configured to acquire native video data from the video source over the first interface.

Accordingly, the producing unit 3006 is configured to produce a second video signal to be displayed at the second frame rate using the free running timing signals which have been generated, the second video signal to be displayed comprising the native video data acquired from the video source.

Additionally, the generating unit 3004 is configured to generate second timing signals after the signal from the first video source is acquired, the second timing signals being adjusted to lock with timing signals of the video source such that a frame rate of the receiving device synchronises with the first frame rate of the first video source. The producing unit 3006 is then configured to produce a third video signal to be displayed at the first frame rate using the second timing signals, the third video signal to be displayed comprising the native video data acquired from the video source.

In this manner, apparatus 3000 enables a receiver device to provide a responsive low latency display of video following the starting-up of a video source or transmitting device in a system for distributing video data over a network.

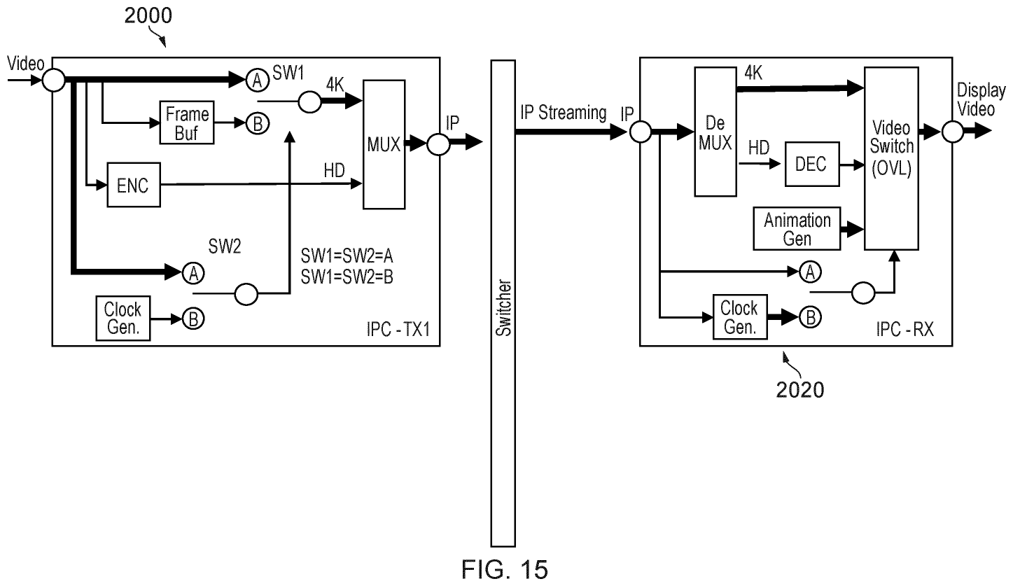

FIGS. 15 to 18 of the present disclosure illustrate an example application of the apparatus 3000 to the distribution of video data over a network. Further details regarding the units and configuration of apparatus 3000 can be understood from these examples.

Consider, now FIG. 15 of the present disclosure. FIG. 15 of the present disclosure illustrates an example system for distributing video data over a network in accordance with embodiments of the disclosure.

In this example a single device 2000 is provided on the transmitting side. Furthermore, a single device 2020 is provided on the receiving side. The receiving device 2020 may include, or be an example of, an apparatus 3000 as described with reference to FIG. 14 of the present disclosure.

The receiving device 2020 receives (e.g. with acquiring unit 3002 of apparatus 3000) video data (IP streaming) over the IP network from the transmitting device 2000. This video data is generated by the transmitting device 2000 from a feed video received from a video source (not shown). The receiving device produces a display video (Display Video) which can be displayed on a display device (not shown), with the display video being produced (e.g. by the producing unit 3006 of apparatus 3000) based on the video data received from the transmitting device 2000. According to embodiments of the disclosure, the receiving device 2020 comprises a clock generator (e.g. generating unit 3004) which is used in order to generate a free running video clock locally on the receiver side. This free running video clock is used in order to enable responsive display of video data from the transmitting device when a video source is switched on. For example, this may be when a video source, such as an medical endoscope, is first switched on (i.e. booted-up or turned on) during a surgical situation.

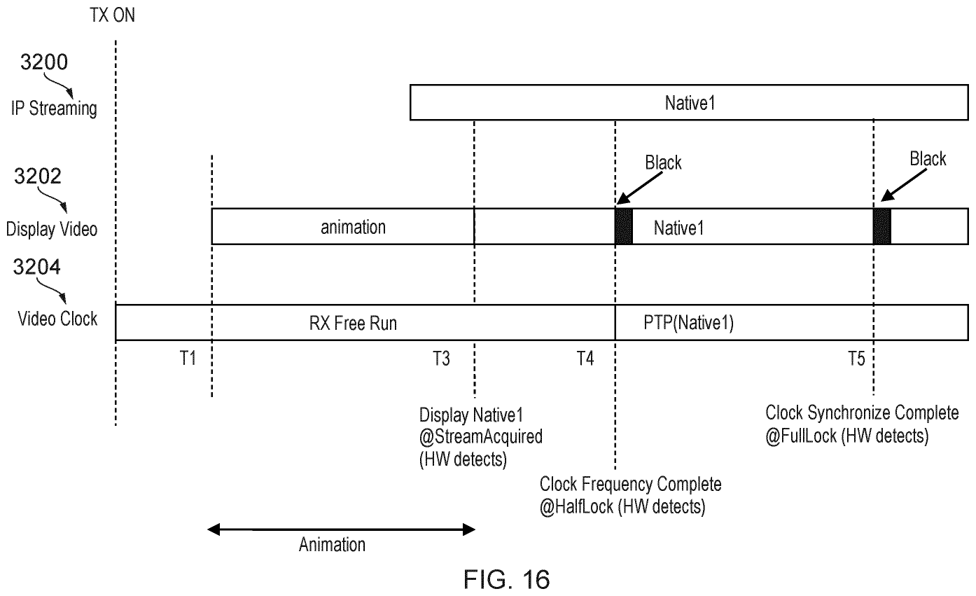

FIG. 16 of the present disclosure illustrates an example timing chart when starting-up a video source in accordance with embodiments of the disclosure (such as when starting-up the medical endoscope video source during surgery).

Three distinct portions of the timing chart are shown; namely, an IP Streaming portion 3200, a Display Video portion 3202 and a Video Clock portion 3204. Each of these three portions share the same time axis (with time increasing horizontally from left to right in the timing chart illustrated in FIG. 16 of the present disclosure).

The timing chart begins at TX ON, when the video source (such as the medical endoscope device) is switched on. At this stage, no data is provided over by IP Streaming 3200 over the IP network. Moreover, no Display Video data is produced by the receiving device 2020 for display by a display device.

However, according to embodiments of the disclosure, when the receiving device receives a signal indicating that the video source has been switched on (i.e. TX ON) the receiving device generates a free running video clock (e.g. free running timing signals), locally, on the receiver side. The signal indicating that the video source has been switched on may be received by acquiring unit 3002. Moreover, the free running video clock may be generated by generating unit 3004. As such, at time T1 the receiver device can display initial image data (such as an animation) even before data is transmitted by the transmitting device 2000 over the IP network—with the initial image data being displayed using the free running video clock which has been generated on the receiver side. Indeed, the initial image data may, in some examples, be generated by generating unit 3004 locally within the receiving device. However, in other examples, the initial image data may be received or otherwise acquired by the acquiring unit 3002. As such, the free running clock on the receiver side, RX, is used to display initial image data at a second frame rate (different from the frame rate of the transmitting device) until the video clock of the transmitting device has been reconstructed on the receiving side.

Accordingly, as soon as the video source (such as the medical endoscope device) is switched on, the receiving device 2000 produces Display Video which is to be displayed on a display device. Therefore, the user can understand that the instruction to turn on the video source has been successfully implemented and that video data from the video source will be displayed once received. The video for display may be produced by the producing unit 3006 of apparatus 3000.

While the initial image data is described as being an animation, the present disclosure is not limited in this regard. That is, the initial image data may be any image data which is to be displayed on a display before video data is received from the video source. In some examples, this initial image data may include certain information providing details of the characteristics of the video source which has been activated. In other examples, a simple text message may be displayed informing the user that video data from the video source will be displayed once received. The type of initial image data which is displayed will vary depending on the situation to which the embodiments of the disclosure are applied.

The animation—initially displayed at time T1, is produced by the receiving device 2020 for display until time T3. Time T3 is a time shortly after the transmitting device 2000 begins transmitting video data from the video source over the IP network. That is, once the video data from the video source is received by the receiving device 2020 over the IP network, this video data—Native1—is used by the receiving device 2020 to produce the Display Video for display on a display device (not shown). Advantageously, according to embodiments of the present disclosure, the video received from the video source—Native1—is used to produce the Display Video using the free running clock RX which has been generated on the receiver side. As such, the Native1 video can be displayed even before the video clock of the transmitting device 2000 has been reconstructed on the receiver side. In comparison to FIG. 7 of the present disclosure, for example, the Native1 video is displayed, according to the present disclosure, using the free running clock RX such that there is no unstable period before the video clock of the transmitting device has been reconstructed on the receiver side. That is, because the video clock generated on the receiver side is a stable clock, there is no instability in the display of the Native1 video before the video clock of the transmitting device 2000 has been reconstructed on the receiver side. Moreover, in comparison to the example illustrated in FIG. 9 of the present disclosure, use of a frame buffer is not required. As such, the reduction in the level of disruption when providing the Native1 video of the video source following the start-up of the video source can be achieved without an increase in the latency of the system.

It will be appreciated that the manner by which the generating unit 3004 generates the free running video clock on the receiver side is not particularly limited in accordance with embodiments of the disclosure. Any suitable method which is used in the art may be used in order to generate the free running video clock (which is an example of timing signals for display of the video data). The present disclosure is not particularly limited in this respect.

Hence, the Native1 video data, using the free running clock RX on the receiver side, is used in order to produce the Display Video from T3 to T4.

At time T4, the receiver achieves a half lock of the video clock on the receiver side with the video clock of the transmitting device (locking with the frequency of the video clock of the transmitting device). This enables the video clock of the transmitting device 2000 to be used on the receiver side in order to produce the Display Video for display. Accordingly, at time T4, the receiving device 2020 uses the reconstructed video clock of the transmitting device 2000 (second timing signals)—PTP(Native1)—in order to produce the Display Video for display (using the Native1 video data which is received over the IP network).

Then, at time T5, a full lock with the video clock of the transmitting device 2000 is achieved (being a lock on both the frequency and phase of the video clock of the transmitting device). The video clock of the receiving device 2020 is therefore fully synchronised with the video clock of the transmitting device 2000 (e.g. third timing signals). As such, the video can be displayed at the frame rate of the transmitting device (e.g. the first frame rate) using the video clock which has been reconstructed.

Small visual glitches (disturbances) are seen shortly after the time T4 and T5 in the Display Video, as the video clock which is used to produce the display video (by the receiving device 2020) is corrected to the video clock of the transmitting device 2000. Nevertheless, use of the free running clock RX on the receiver side in accordance with the embodiments of the disclosure enables initial image data to be used to produce Display Video (being video data for display) by the receiving device 2020 even before any image data is received from the transmitting device 2000. Moreover, the video data received from the transmitting device over the IP network can be displayed with increased stability between the time T3 and T4 (i.e. as soon as the video data is received and even before a lock with the video clock—timing signals—of the transmitting device 2000 has been achieved). As such, embodiments of the present disclosure the present disclosure allows for subframe latency in video transfer (which is possible because the video clock of the video source is reconstructed at the receiving end for every new video source that is shown) while, at the same time, preventing blackout periods on monitors during the period where the new video clock is reconstructed by the receiving device 2020. This provides a responsive low latency system and leads to a greatly improved user experience when switching a new video source on.

Likewise, a free running clock generated locally on the receiver side can be used to reduce disruption and provide responsive low latency video on start up of a video source in a system where video footage is streamed simultaneously in two qualities over the network by a transmitting device (i.e. where multiple video streams can be received by the receiving device 2002 over the IP network at the same time).

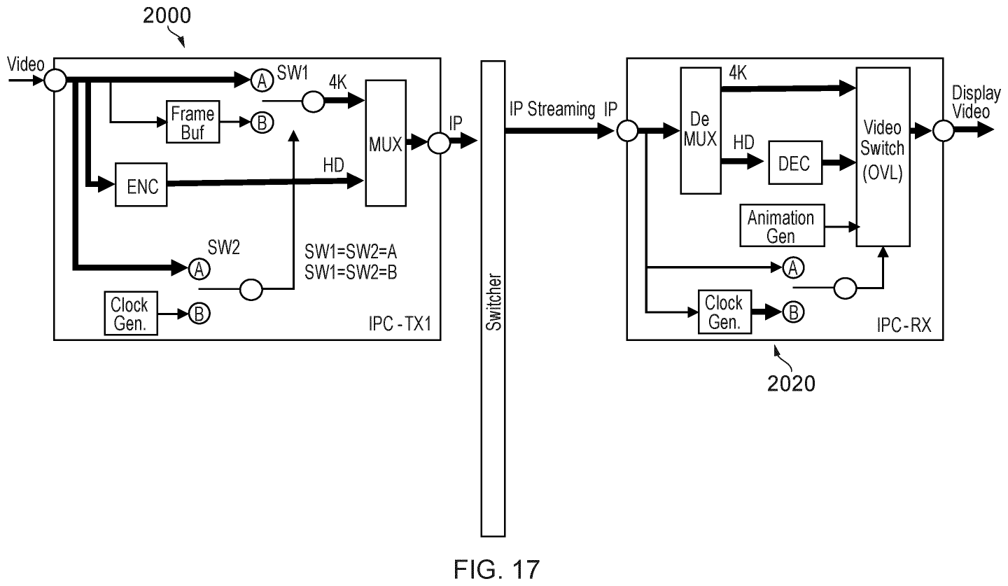

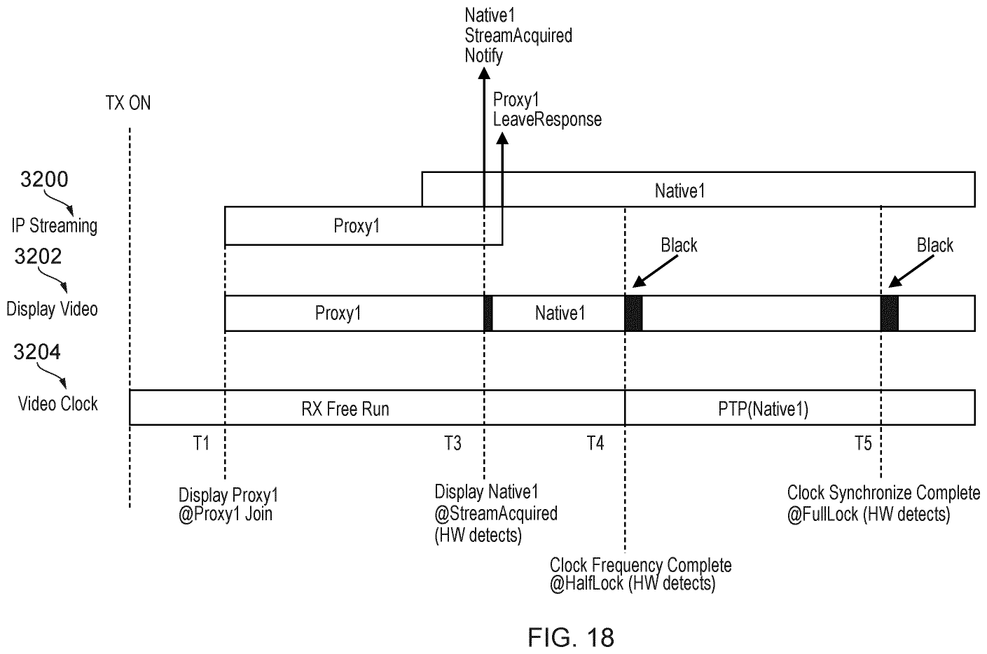

Consider, now, the example illustrated in FIGS. 17 and 18 of the present disclosure. The system illustrated in FIG. 17 (which is similar to the system configuration described with reference to FIG. 15 of the present disclosure) comprises a single transmitting device 2000 is provided on the transmitter side and a single receiving device 2020 is provided on the receiving side of the network. However, in this example the receiving device 2020 is capable of receiving at least two video feeds over the IP network at the same time. Specifically, in this example, a native video feed corresponds to a 4K video feed, while a proxy video feed corresponds to HD video feed (with the two video feeds being decoupled by a demultiplexer and decoder in the receiver, for example). More generally, the native video feed is meant for ultra low latency display and requires locked video clocks (between the receiving device 2020 and the transmitting device 2000), while the proxy video feed is a bandwidth optimized version of the same footage as displayed by the native video feed. Optimized bandwidth comes at the expense of a slightly higher latency than the native video feed, but no longer requires a locked clock between the transmitting device 2000 and the receiving device 2020 for display.

The proxy video feed received over the IP network can, in certain examples, be used as the initial image data which is displayed by the receiving device even before the native video feed has been received from the transmitting device. As such, in this example, the acquiring unit 3002 of apparatus 3000 acquires the initial image data (being the proxy video feed).

Turning now to FIG. 18 of the present disclosure, an example timing chart when starting-up a video source in accordance with embodiments of the disclosure is shown. This timing chart may correspond to a timing chart as would be seen when a video source is turned on in the system illustrated in FIG. 17 of the present disclosure, for example.

The timing chart begins at time TX ON (when a signal from the video source and/or transmitting device 2000 indicates that the video source has been switched on by the user). Prior to this time, no data is received over the IP network and no data is produced for display on a display screen. This can be seen in the IP streaming portion 3200 and the Display Video portion 3202 of FIG. 18.

At time TX ON, the receiving device 2020 of embodiments of the disclosure generates a free running video clock RX on the receiving side.

Then, at time T1, the transmitting device 2000 of FIG. 17 of the present disclosure begins to transmit a proxy video feed—Proxy 1—over the IP network. As explained with reference to FIG. 17 of the present disclosure, the proxy video feed is a bandwidth optimized video feed which does not require a locked clock for display. As such, the transmitting device 2000 is able to transmit the proxy video feed—Proxy1—over the IP network in a short time following the start up of the video source. In contrast to the native video feed—Native1—the transmitting device 2000 itself does not require a stable video clock to transmit the proxy video data—Proxy1. As such, even though the transmitting device 2000 cannot recognize the stable clock of the video source immediately following the booting up of the video source, and cannot therefore send the native video stream over the IP network, the transmitting device is able to send the proxy video feed—Proxy1—over the IP network at a much earlier stage following the booting up of the video source.

Furthermore, at time T1 (when the proxy video feed is received by the receiving device 2020) the receiving device 2020 is able to produce Display Video (being video data for display on a display device (not shown)) using the free running clock RX which has been generated on the receiver side. As such, at a time T1 very soon after the start up of the video source (which occurs at time TX ON) the receiving device 2020 is able to produce Display Video data showing video from the video source which can be displayed to a user. As such, the user is able to see video from the video source (such as a medical endoscope) very quickly following the start up of that video source.

At a time after T1, while the proxy video feed is being displayed, the receiving device 2020 receives the native video feed—Native1—from the transmitting device 2000. As previously described, the native video feed—Native1—shows the same video content (e.g. same view of the scene from the video source) as the proxy video feed but with different video characteristics (such as lower latency). Therefore, once the native video feed is available, it is desirable that the native video feed—Native1—is displayed to the user. However, as previously explained, the native video feed requires a locked clock for display. Therefore, it is typically understood that the native video feed cannot be displayed without disruption to the user until a lock with the video clock of the transmitting device 2000 has been achieved by the receiving device 2020.

Advantageously, according to embodiments of the disclosure, the receiving device 2020 is able to use the free running video clock RX which has been generated locally on the receiver side (e.g. by the receiving device 2020 as illustrated with reference to FIG. 17 of the present disclosure (or generating unit 3004)) in order to display the native video feed as soon as it has been acquired from the transmitting device (that is, even before a lock with the video clock of the transmitting device 2000 is achieved). Hence, at time T3, the receiving device 2020 uses the Native1 video which has been received, with the free running video clock which has been generated on the receiver side, in order to produce the Display Video for display on a display device (not shown).

When the native video feed has been displayed by the receiving device 2002, the transmitting device 2000 stops transmitting the proxy video feed. However, since an overlap exists between the start of the streaming of the native video feed over the IP network and the end of the streaming of the proxy video feed over the IP network, no disruption occurs in the display of the native video feed from the video source (i.e. Native1). The user therefore does not experience a significant period of blackout or disruption on the display.

In this example, the receiving device 2020 continues to produce the Display Video with the native video feed received from the transmitting device 2000 using the free running video clock RX which has been generated by the receiving device 2020 until time T4. The time indicated by T4 is the time at which the receiving device 2020 actually achieves a frequency lock with the video clock of the transmitting device 2000. Accordingly, at this stage, the receiving device 2020 can switch to using this new video clock (reconstructed from the video clock of the transmitting device 2000) to produce the Display Video (e.g. using the producing unit 3006 of apparatus 3000). Hence, at time T4, the video clock used by the receiving device switches to PTP(Native1).

Then, at time T5, a full lock with the video clock of the transmitting device 2000 is achieved. There is a small visual disturbance (glitch) as the video clock used by the receiving device 2000 corrects to the video clock which is locked with the video clock of the transmitting device 2000 (indicated by the blacked-out portion of the Display Video after T5). However, once this small correction has been performed, the video clock of the receiving device 2020 is fully synchronised with the video clock of the transmitting device 2000.

In the manner described with reference to the examples of FIGS. 17 and 18 of the present disclosure, embodiments of the present disclosure are therefore able to significantly reduce the amount of time following the start-up of a video source before which video from a video source can be displayed to the user. This improves the responsiveness and operability of the system when starting up a video source. Moreover, through use of the free running video clock RX generated by the receiver (i.e. locally on the receiver side), low latency video can be displayed to the user at an early stage with reduced levels of disturbance. In fact, stable low latency video can be displayed to the user even before the video clock of the receiving device 2020 has synchronised with the transmitting device 2000. Accordingly, a responsive low latency system can be achieved which has significantly improved user experience when switching on a new video source.

Now, as explained with reference to FIG. 18 of the present disclosure, a number of visual glitches (e.g. black screens) may be experienced when switching from the initial image data (i.e. the animation or the proxy video data acquired by apparatus 3200) to the native video data. Moreover, a number of visual glitches (e.g. black screens) may also be experienced in the Display Video (i.e. the video displayed on a display device) whenever a change or correction to the video clock used by the receiving device 2020 is made. That is, since a change of video clock also requires a monitor (or other display device) to resynchronise to this new clock, a change of video clock always causes a (short) visual glitch on the screen.

Hence, according to embodiments of the disclosure, the apparatus 3200 (or receiving device 2020) is further configured to generate a display signal to display the third video signal a predetermined time after the native video signal is acquired (with the predetermined time, in some examples, corresponding to a predetermined time of occurrence of an event (such as frequency lock of the video clock)). That is, because the native video feed is displayed as soon as it is received (being even before the time when the video clock of the transmitting device is reconstructed on the receiving side, the video clock of the receiving device used in order to display the native video feed undergoes a number of small corrections (with each of these corrections causing a short glitch to the display video). However, by delaying the time until which the native video is displayed, it is possible to reduce the number of corrections to the video clock of the receiving device which are experienced while the native video feed is displayed (thus reducing the number of glitches). Moreover, because the proxy video feed can be displayed without dependence on the video clock, the proxy video feed can be used in order to display video from the video source (while the video clock of the receiving device is being synchronised with that of the transmitting device) without visual disturbance.

The proxy video feed—being bandwidth optimised—is not a ultra low latency video feed (such as the native video feed). Accordingly, in situations where ultra low latency video is required, it may be advantageous that the native video feed is displayed as soon as it is received (as described in FIG. 18 of the present disclosure). On the other hand, in some situations, a constant view of the video from the video source (without visual glitches) may be more advantageous—in these situations the display of the native video feed can be delayed for a predetermined time (such as an amount of time selected by a user in a configuration phase) until the video clocks have been synchronised.

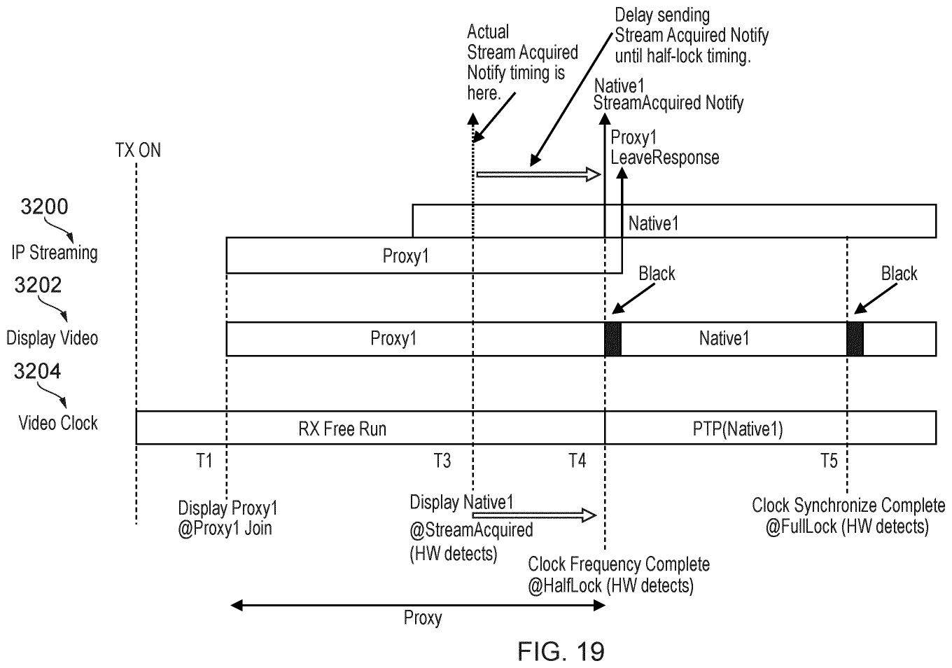

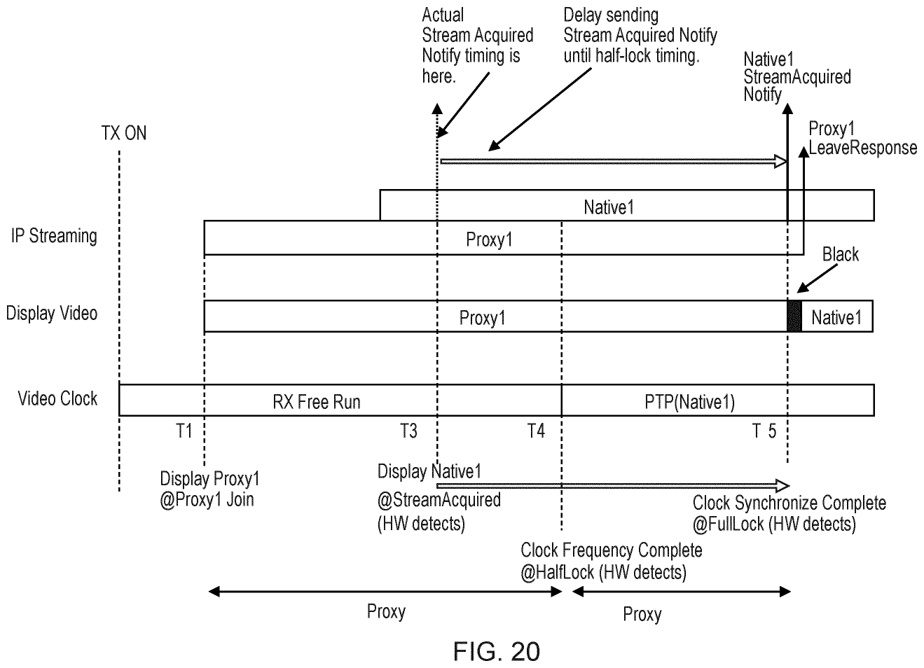

This feature is explained in more detail with reference to FIGS. 19 and 20 of the present disclosure. FIG. 19 of the present disclosure illustrates an example timing chart when starting-up a video source in accordance with embodiments of the disclosure. This timing chart is an example of a timing chart which may be experienced when turning on a video source in the system of FIG. 17 of the present disclosure. However, in contrast to FIG. 19 of the present disclosure, the display of the native video feed is delayed for a predetermined time after it has been acquired by the receiving device 2020 (i.e. by producing unit 3006 of apparatus 3000, for example).

The timing chart begins at time TX ON, which is a time at which the video source is turned on. At this stage, the receiving device generates a free running video clock RX on the receiver side. At time T1, the receiving device receives the Proxy1 video feed from the transmitting device 2000 and uses the Proxy1 video feed in order to produce the Display Video. Hence, the Proxy1 video feed from the video source is displayed to the user on a display device (not shown).

A short time before time T3, the Native1 video feed is acquired by the receiving device 2020. Hence, both the Proxy1 video feed and the Native1 video feed are being streamed simultaneously by the transmitting device 2000 and the receiving device 2020. At time T3, the receiving device 2020 can then begin to reconstruct the video clock of the transmitting device 2000 using the packets of the Native1 video feed which are being received from the transmitting device 2000. However, in contrast to FIG. 18 of the present disclosure, the receiving device continues to use the Proxy1 video feed in order to produce the Display Video. Hence, even after the Native1 video feed is acquired, the Proxy1 video feed is displayed to the user.

Then, at time T4, the receiving device 2020 achieves a frequency lock with the video clock of the transmitting device 2000. In this example, the receiving device switches to the Native1 video feed only when the half-lock timing (frequency lock) with the transmitting device 2000 has been achieved. After time T4, the user therefore sees the ultra low latency Native1 video feed on the display.

At time T5, the video clock of the receiving device is fully synchronised with the video clock of the transmitting device. A small visual disturbance is seen as the video clock of the receiving device used to produce the display video corrects to the timing of the video clock of the transmitting device.

However, because the display of the Native1 video feed is delayed until the video clock of the receiving device 2020 has achieved a half lock (frequency lock) with the video clock of the transmitting device 2000, the number of glitches which are seen in the Display Video produced by the receiving device 2020 is reduced. That is, there are only two visual glitches in the Display Video as illustrated in FIG. 19 of the present disclosure, in contrast to the three visual glitches which are illustrated in the Display Video produced by the receiving device 2020 as illustrated in FIG. 18 of the present disclosure.

The example of FIG. 19 of the present disclosure is therefore an example of the delay of the display of the native video feed until a half lock/frequency lock with the video clock of the transmitting device 2000 has been achieved by the receiving device 2020.

A further example of a timing chart when starting-up a video source in accordance with embodiments of the disclosure is illustrated in FIG. 20 of the present disclosure. This timing chart is an example of a timing chart which may be experienced when turning on a video source in the system of FIG. 17 of the present disclosure. However, in contrast to the example of FIG. 19 of the present disclosure, the receiving device 2020 is configured to delay the use of the Native1 video feed to produce the Display Video until the video clock of the receiving device 2020 is fully synchronised (i.e. both frequency and phase) with the video clock of the transmitting device 2000. This is achieved at time T5 in FIG. 20 of the present disclosure. Until this time, the receiving device 2000 continues to use the Proxy1 video feed in order to produce the Display Video (being the video for display to a user on a display device (not shown)). As such, the Proxy1 video feed is displayed in the period of T1 to T4 (with the free running video clock as generated on the receiver side) and the period of T4 to T5 (with the PTP(Native1) video clock) until a full lock with the video clock of the transmitting device 2000 is achieved on the receiver side. Only at this stage, is the Native1 video feed displayed to the user. Hence, the number of visual disturbances (glitches) is further reduced to only a single disturbance—which occurs when the receiving device 2020 switches from the Proxy1 video feed to the Native1 video feed at time T5.

Therefore, the number of visual glitches which are experienced when switching from the initial image data to the native video data is reduced. This further reduces the disruption experienced when a new video source is started, while ensuring that a responsive low latency video is displayed following the start up of a new video source. The example of FIG. 20 of the present disclosure is therefore an example of the delay of the native video for a predetermined time until the video clock of the receiving device 2020 is fully synchronised with the video clock of the transmitting device 2000.

It will be appreciated that the predetermined delay is not limited to these examples. The predetermined time delay may also be set in terms of an absolute period of time or an absolute number of frames. Moreover, in examples, the predetermined time may be adaptable in accordance with an input or instruction received from the user. This enables the user to configure the system such that the optimum balance between rapid display of the native video feed and an amount of visual glitches is achieved. In other examples, the predetermined time delay may be adaptable by the apparatus 3000 in accordance with one or more characteristics of the video source and the display device (e.g. properties related to booting up time or the like of these devices).

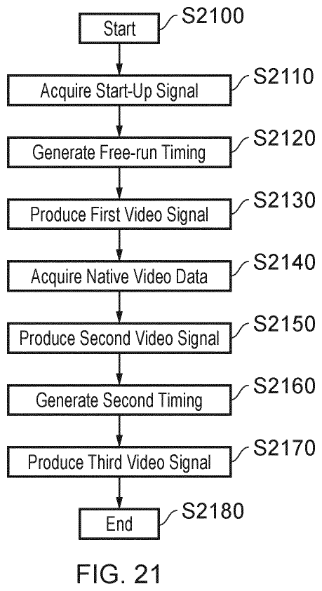

Hence, more generally, a method of distributing video data over a network is provided in accordance with embodiments of the disclosure. An example of the method of distributing video data over a network is illustrated in FIG. 21 of the present disclosure. In some examples, the method may be performed by a device such as device 2020 on the receiver side as illustrated in FIGS. 15 and 17 of the present disclosure, for example. The method may be performed by apparatus 3000 or a device as described with reference to FIG. 28 of the present disclosure, for example.

The method starts a step S2100, and proceeds to step S2110.

In step S2110, the method comprises acquiring a signal from a video source configured for outputting video data over a first interface of the network, the video data including native video data having a first frame rate and the signal indicating that the video source has been switched on.

The method proceeds to step S2120.

In step S2120, the method comprises generating free running timing signals when the signal from the video source is acquired.

The method proceeds to step S2130.

In step S2130, the method comprises producing a first video signal to be displayed at a second frame rate using the free running timing signals which have been generated, the first video signal to be displayed comprising initial image data for display before native video data is acquired from the video source.

The method then proceeds to step S2140.

Then, in step S2140, the method comprises acquiring native video data from the video source over the first interface.

The method then proceeds to step S2150.

In step S2150, the method comprises producing a second video signal to be displayed at the second frame rate using the free running timing signals which have been generated, the second video signal to be displayed comprising the native video data acquired from the video source.

The method then proceeds to step S2160.

In step S2160, the method comprises generating second timing signals after the signal from the first video source is acquired, the second timing signals being adjusted to lock with timing signals of the video source such that a frame rate of the receiving device synchronises with the first frame rate of the first video source.

The method then proceeds to step S2170.

In step S2170, the method comprises producing a third video signal to be displayed at the first frame rate using the second timing signals, the third video signal to be displayed comprising the native video data acquired from the video source.

The method then proceeds to, and ends with, step S2180.

Of course, it will be appreciated that the method of distributing video data over a network as provided by the present disclosure is not particularly limited to the specific example illustrated in FIG. 21 of the present disclosure.

That is, a number of the steps illustrated in FIG. 21 of the present disclosure may be performed in a particular sequence (such as that illustrated in FIG. 21 of the present disclosure) or, alternatively, may instead by performed in parallel with each other. The step S2160 of generating the second timing may be performed as soon as the native video data is acquired, for example even before (or at the same time as) the second video signal is produced and displayed, for example.

Through the method of distributing video data over a network in accordance with embodiments of the disclosure, it is possible to provide a responsive low latency display of video following the starting-up of a video source or transmitting device in a system for distributing video data over a network.

### Second Embodiment (Free Running RX+TX)

In a second embodiment of the present disclosure, the inventors have realised that the use of a free-running clock on the receiver device coupled with a free-running clock on the transmitter side produces an advantageous technical effect of a further reduction in the disturbance in the video displayed after the start up (or booting up) of a video source (such as a medical imaging device or the like) while ensuring that low latency can be maintained. Hence, the second embodiment of the disclosure provides for responsive low latency display of video following the starting-up of a video source or transmitting device in a system for distributing video data over a network.

Specifically, in this second embodiment of the present disclosure, a free-running video clock which is generated locally at the transmitting side is used by the transmitting device for a short time period following the start up (booting up) of a video source. The purpose of this step is mainly to distribute video data over the network (e.g. by IP streaming) for display right after booting up the video source. While using the free running clock on the transmitting side, an additional 1 frame of latency occurs. However, this happens only during a short period of time following the initial booting up of the video source.

Then, a short time after, a free-running video clock at receiving end is established, and the input video clock of the video source is used instead of free-running video clock in the transmitting device at the same time. In other words, as soon as the video clock of the video source is reconstructed in the transmitting side, the video clock of the transmitting device is changed from a free-running video clock to the input video clock of the video source. Any additional latency caused by the use of the free running clock on the receiver side is therefore limited only to the period before the transmitting device can determine the stable video clock of the imaging device after the initial booting up of the video source.

In other words, in contrast to the first embodiment of the disclosure (such as the example illustrated with reference to FIG. 18 of the present disclosure) the transmitting device is able to transmit the native video feed to the receiving device at an earlier time following the initial booting up of the video source (even before the transmitting device recognizes the stable clock of the video source). Indeed, in the example of FIG. 18 of the present disclosure, the transmitting device 2000 first transmitted a proxy video feed over the network during the time while the stable clock of the video source was being reconstructed. Then, once the stable clock of the video source was reconstructed by the transmitting device 2000, the native video feed was transmitted over the network using the video clock which had been reconstructed. However, in this second embodiment of the disclosure, the native video feed is, itself, transmitted over the network by the transmitting device even before the stable clock of the video source has been reconstructed on the transmitting side (using a free running clock generated locally on the transmitting side). Then, once the video clock of the video source has been reconstructed, the transmitting device proceeds to transmit the native video feed using the stable video clock of the video source.

Accordingly, this second embodiment of the disclosure priorities the provision of the native video feed to the receiving device at the earliest time possible following the initial booting up of a video source. The native video feed is a high quality feed meant for ultra low latency. As such, high quality video can be provided for display, without disturbance, while ensuring that a low latency environment is obtained and maintained as quickly as possible in the video distribution system.

Hence, according to a second embodiment of the disclosure, an apparatus 3100 for a receiving device 2020 of a system for distributing video data over a network is provided. An example configuration of the apparatus 3100 is illustrated in FIG. 22 of the present disclosure. The apparatus 3100 comprises an acquiring unit 3102, a producing unit 3104 and a generating unit 3106.

The acquiring unit 3102 is first configured to acquire a signal from a video source configured for outputting video data over a first interface of the network, the video data including native video data having a first frame rate and the signal indicating that the video source has been switched on.

Then, the acquiring unit 3102 is further configured to acquire first free running timing signals from the video source.

Accordingly, the producing unit 3104 of apparatus 3100 is configured to produce a first video signal to be displayed at a second frame rate using the first free running timing signals received from the video source, the first video signal to be displayed comprising initial image data for display before native video data is acquired from the video source.

The acquiring unit 3102 is also configured to acquire first native video data from the video source over the first interface, the first native video data from the video source being subject to a frame buffer by the video source.

Producing unit 3104 is then configured to produce a second video signal to be displayed at the second frame rate using the free running timing signals received from the video source, the second video signal to be displayed comprising the first native video data acquired from the video source.

Acquiring unit 3102 then acquires second native video data from the video source over the first interface, the second native video data from the video source not being subject to a frame buffer by the video source.

At this stage, generating unit 3106 of apparatus 3100 is configured to generate second free running timing signals when the signal from the video source is received.

Producing unit 3104 thus produces a third video signal to be displayed at a third frame rate using the second free running timing signals which have been generated, the third video signal to be displayed comprising the second native video data acquired from the video source.

Generating unit 3106 of apparatus 3100 is configured to generate second timing signals after the signal from the video source is received, the second timing signals being adjusted to lock with timing signals of the video source such that a frame rate of the receiver synchronises with the first frame rate of the video source. Finally, the producing unit 3104 produces a fourth video signal to be displayed at the first frame rate using the second timing signals, the fourth video signal to be displayed comprising the second native video data received from the video source.

Hence, in this manner, the apparatus 3100 for a receiving device of a system for distributing video data over a network provides for responsive low latency display of video following the starting-up of a video source in a system for distributing video data over a network.

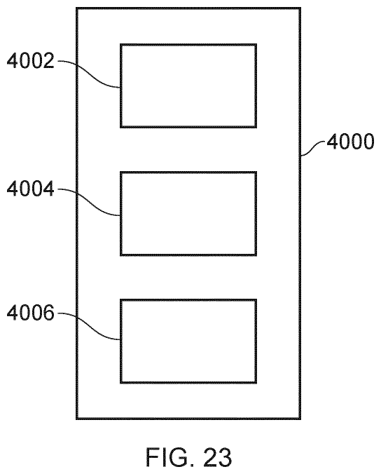

Turning now to FIG. 23 of the disclosure, an example of an apparatus 4000 for a video source (transmitter side device) of a system for distributing data over a network is illustrated. The apparatus 4000 comprises a transmitting unit 4002, a generating unit 4004 and a switching unit 4006.

According to embodiments of the disclosure, the transmitting unit 4002 is configured to transmit a signal to a receiving device indicating that the video source has been switched on. Then, generating unit 4004 is configured to generate first free running timing signals.

Further, transmitting unit 4002 is configured to transmit the first free running timing signals (which have been generated by generating unit 4004) to the receiving device (being a receiving device comprising an apparatus such as apparatus 3100 as described with reference to FIG. 22, for example).

Then, transmitting unit 4002 is configured to transmit native video data of the video source to the receiving device, the native video data being subject to a frame buffer and having a first frame rate established by the first free running timing signals.

The switching unit 4006 is configured to switch to input timing signals of the video source.

Finally, transmitting unit 4004 of apparatus 4000 is configured to transmit native video data to the receiving device, the native video data not being subject to a frame buffer and having a second frame rate established by the input timing signals of the video source.

Hence, in this manner, the apparatus 4000 for a transmitting device of a system for distributing video data over a network provides for responsive low latency display of video following the starting-up of a video source in a system for distributing video data over a network.

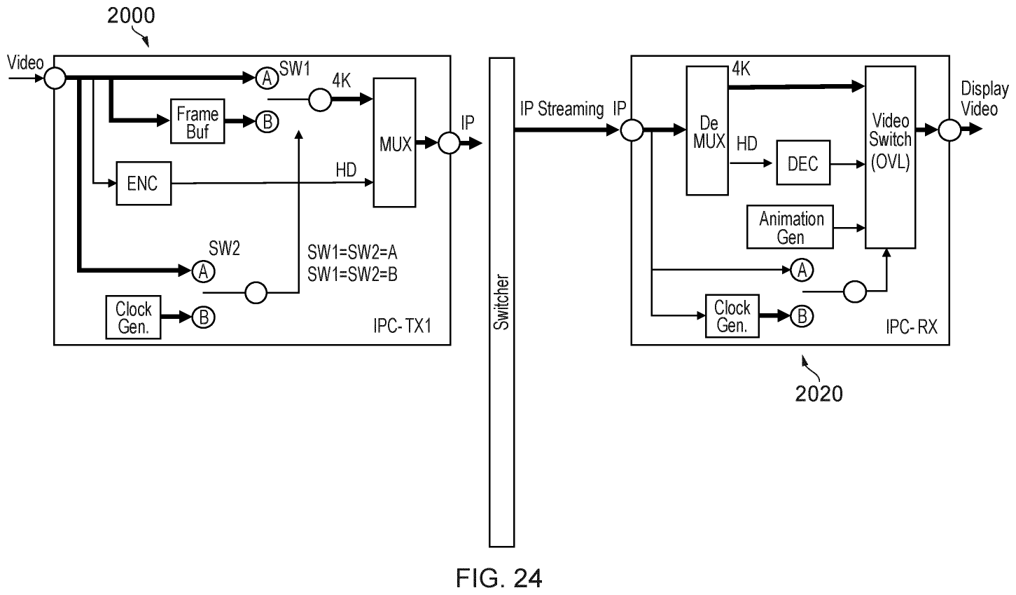

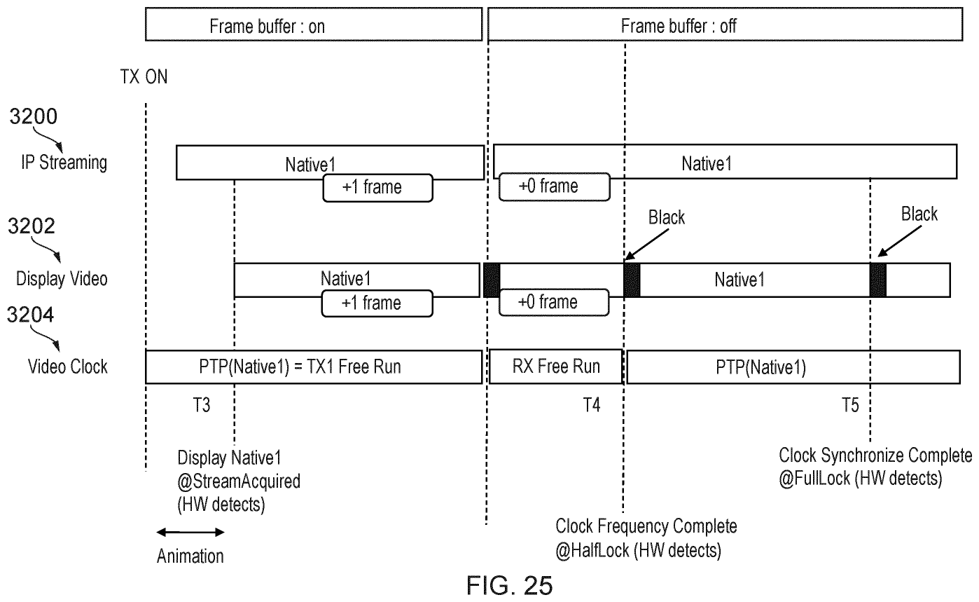

FIGS. 24 and 25 of the present disclosure illustrate an example application of the apparatus 3100 (for the receiver side) and apparatus 4000 (for the transmitter side) to the distribution of video data over a network. Further details regarding the apparatus 3100 and the apparatus 4000 will therefore be understood with reference to the example of FIGS. 24 and 25 of the present disclosure.

Consider now FIG. 24 of the present disclosure. Here, an example system for distributing video data over a network in accordance with embodiments of the disclosure is illustrated.

In this example system, a transmitting device 2000 and a receiving device 2020 are provided. The transmitting device 2000 is configured to receive video from a video source (not shown). Then, the transmitting device 2000 transmits the video from the video source over an IP network (IP Streaming) via a switcher to the receiving device 2020. The receiving device acquires the data which has been transmitted by the transmitting device over the IP network and produces a video for display (Display Video). The video may be displayed to the user on a display screen (not shown).

It will be appreciated that, as previously explained, different video sources (imaging devices) have different video characteristics including, for example, different time periods following initial boot up during which there is a certain amount of jitter in the video clock of the video source. Indeed, during this period (following the booting up of the video source), the transmitting device 2000 cannot recognise the stable clock of the video source and cannot send IP streaming data (such as video data) to the receiving device 2020. In other words, there is, generally, an unstable period when the video source is switched on during which no video data can be produced for display by the receiving device 2020. For at device which the power on and power off are frequently operated (such as a medical video source during a medical operation) the amount of disturbance can become very significant.

However, according to the present embodiment of the disclosure, the transmitting device 2000 (or apparatus 4000) generates a free running video clock which can be used to transmit video data to the receiving device 2020 even before the stable video clock of the video source has been established and reconstructed. Furthermore, the receiving device 2020 (or apparatus 3100) generates a free running clock locally on the receiver side which can be used in order to produce the display video using the data which is received from the transmitting device (over the network) even before the video clock of the transmitting device has been reconstructed on the transmitting side.

FIG. 25 illustrates an example timing chart when starting-up a video source in accordance with embodiments of the disclosure. The timing chart illustrated in FIG. 25 is an example of a timing chart following the initial booting up of a video source in the system of FIG. 24 of the present disclosure.

The example timing chart of FIG. 25 of the present disclosure is, again, separated into three distinct portions: an IP streaming portion 3200, a Display Video portion 3202, and a Video Clock portion 3204. These three portions of the timing chart share the same time axis. Time increases from left to right on the horizontal axis in the example of FIG. 25. The IP streaming portion 3200 of the timing chart indicates the data which is being streamed over the IP network of FIG. 24 of the present disclosure at any given time following the initial booting up of a video source (which occurs at time TX ON). The Display Video portion 3202 indicates the video data which is being produced for display by the receiving device 2020 at any given time following the initial booting up of the video source. Finally, the Video Clock portion 3204 indicates the video clock which is being used by the receiving device 2020 in order to stream the video data over the IP network at any time following the initial booting up of the video source.

The time, in this timing chart, starts at TX ON. This is when the video source is initially booted up for use by the user.

At this stage, the transmitting device 2000 receives a signal that the video source has been started. However, the video clock of the video source is unstable and cannot be reconstructed by the transmitting device. Accordingly, the transmitting device 2000 generates a free running clock TX1 locally on the transmitting side. This transmitting clock TX1 is provided to the receiving device (i.e. the transmitting device signals the timing of the free running timing clock TX1 to the receiving device). The free running clock (e.g. timing signals) may be generated by generating unit 4004 of apparatus 4000 and transmitted to the receiving device by the transmitting unit 4002 of apparatus 4000.

Then, a short time before T3, the transmitting device 2000 receives the native video feed—Native1—from the video source. Time T3 is a time even before the stable video clock of the video source has been reconstructed by the transmitting device 2000. However, the transmitting device 2000 uses the free running video clock TX1 which has been generated locally in order to transmit the native video stream—Native1—over the network to the receiving device. As such, at T3, the receiving device 2020 uses the native video stream which has been acquired from the transmitting device 2000 in order to produce the video which should be used for display to the user (i.e. Display Video). This may be performed by the producing unit 3104 of apparatus 3100, for example. Therefore, even at time T3 (a time before the video clock of the video source has been reconstructed by the transmitting device 2000) the native video feed of the video source can be displayed to the user. The receiving device 2020 uses the free running clock TX1 which has been generated locally at the transmitting side (by the transmitting device 2000) in order to produce the video for display. Accordingly, the video is displayed with a frame rate of the free running clock TX1 which has been generated locally at the transmitting side (the second frame rate). This is a different frame rate than the native frame rate of the video source (the first frame rate) as the stable video clock of the video source has not yet been reconstructed by the transmitting device.

In some examples, during the time before T3 (following the initial boot of the video source at TX ON) and before the native video feed is received from the transmitting device 2000, the receiving device 2020 may use the free running video clock of the transmitting device TX1, in order to display initial image data (such as an animation or the like) in order to indicate to the user that video data will be displayed once received from the transmitting device 2000. In this manner, the user can understand that the request to boot up the video source and display video from the video source is being acted upon by the system. The initial image data may be generated by generating unit 3106 of apparatus 3100, for example.

Furthermore, it will be appreciated that in the period while the transmitting device 2000 transmits the native video feed of the video source over the network using the free running video clock TX1 which has been generated locally at the transmitting side, the video which is transmitted by the transmitting device 2000 is subjected to a frame buffer which adds an additional frame of latency to the transmission of the video data over the network. The frame buffer is required when the free running video clock TX1 is used by the transmitting device 2000 in order to account for the instability (jitter) in the video clock of the video source following the initial booting up of the video source. That is, the frame buffer enables the transmitting device to drop or repeat an frame of the native video feed received from the video source as necessary in order to provide a stable video feed across the network to the receiving device 2002 (i.e. a video feed without disturbances produced by the jitter of the video source).

However, the frame buffer which is used by the transmitting device 2000 introduces additional latency to the video feed (in the form of an additional frame of latency). As such, while the use of the free running clock TX1 by the transmitting device 2000 enables the native video feed of the video source to be displayed to the user at an early time following the initial booting up of the video source, it is not displayed in ultra low latency—owing to the additional latency introduced by the frame buffer. During this time, a message may, optionally, be displayed to the user indicating that the video is not yet ultra low latency.

Then, at a time between T3 and T4, the transmitting device 2000 achieves a lock with the video clock of the video source. That is, at a time between T3 and T4 (following the initial booting up of the video source at TX ON) the transmitting device is able to reconstruct the stable video clock of the video source. At this time, the transmitting device switches to the use of the input video clock (being the video clock of the video source which has been reconstructed by the transmitting device 2000). The switching from the free running video clock TX1 (generated by generating unit 4004, for example) to the input video clock (or timing signals) of the video source (not shown) may be performed by switching unit 4006 of apparatus 4000 of the present disclosure, for example. Moreover, as the video clock of the transmitting device 2000 is synchronised with the video clock of the video source, the transmitting device no longer needs to use the frame buffer in order to stabilise the video which is being provided over the network to the receiving device 2020. As such, at this time (being the time when the transmitting device 2000 reconstructs the video clock of the video source) the transmitting device 2000 switches the frame buffer off. Accordingly, the increase in the latency of the video displayed to the user owing to the use of the frame buffer is limited to the short period of time before the transmitting device 2000 reconstructs the video clock of the video source). The impact in the increase in the latency of the system is therefore very small.

Furthermore, when the transmitting device 2000 switches to the use of the video clock (timing signals) of the video source, the receiving device 2020 switches to a free running clock RX (second free running timing signals) which has been generated locally on the receiver side (in receiving device 2020—or generating unit 3106 of apparatus 3000—for example). As such, even when the transmitting device 2000 changes from the free running clock of the transmitting device TX1 to the video clock which is synchronised with the video source (the input video clock of the video source), the receiving device 2020 can continue to use the native video feed—Native1—to produce the video for display (i.e. Display Video) even before the new video clock of the transmitting device 2000 has been reconstructed by the receiving device 2020. Accordingly, the native video feed from the video source can be displayed to the user without disturbance or disruption and with ultra low latency at an early time following the initial booting up of the video source. The video is then displayed with a third frame rate using this free running clock RX which has been generated locally on the receiving side. The third frame rate is the frame rate of the video signal when displayed with the free running clock RX which has been generated on the receiver side. This is different from the frame rate of the video source (as the video clock of the video source has not yet been reconstructed on the receiver side). Furthermore, it may be different from the second frame rate (as the free running video clock generated on the transmitter side TX may not be the same as the free running video clock RX).

Indeed, the receiving device 2020 continues to use the free running clock RX which has been generated locally on the receiving side in order to produce the video for display until the time period T4.

At time T4, the receiving device 2020 achieves a lock with the video clock of the transmitting device 2000. That is, using the data packets which have been received from the transmitting device 2000 over the IP network (for example), the receiving device 2020 is able to reconstruct the video clock of the transmitting device 2000 on the receiver side. Specifically, time T4 is the time at which at least the frequency of the video clock of the receiver is synchronised with the video clock used by the transmitting device 2000. Accordingly, at time T4, the receiving device 2020 switches to the use of the video clock which has been acquired from the transmitting from the transmitting device for the production of the video for display to the user. That is, after time T4, the video clock PTP(Native1)—being the video clock used by the transmitting device 2000, as reconstructed from the video source (i.e. the input video clock of the video source), to transmit the data over the network—is used with the native video feed by receiving device 2020 in order to produce the video for display to the user. This may be performed by producing unit 3104 of apparatus 3100, for example.

Then, at time T5, the receiving device 2020 achieves a full lock with the video clock of the transmitting device 2000 (being a reconstruction of the frequency and phase of the video clock of the transmitting device 2000, for example). As such, at time T5, the video clock of the receiving device 2020 achieves a full synchronisation with the video clock of the transmitting device. A small visual disturbance (glitch) may be observed in the display video as the video clock of the receiving device corrects to the video clock of the transmitting device. Nevertheless, according to the present embodiment of the disclosure, the native video feed Native1 of the video source is able to be displayed with stability to the user at an early time following the initial booting up of the video source. Moreover, a ultra low latency environment is established at a very early time following the initial booting up of the video source (even before the final video clock of the transmitting device is reconstructed on the receiver side by the receiving device).

In this manner, the apparatuses of the second embodiment of the disclosure provide for responsive low latency display of video following the starting-up of a video source in a system for distributing video data over a network.

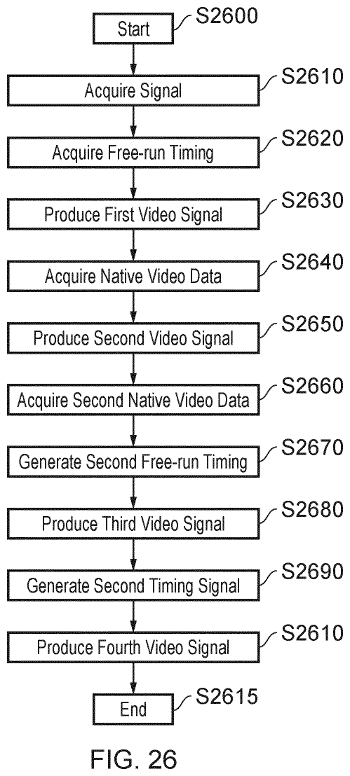

Hence, more generally, a method of a receiving device of a system for distributing video data over a network is provided in accordance with embodiments of the disclosure. An example method is illustrated in FIG. 26 of the present disclosure.

The method starts at step S2600, and proceeds to step S2610.

In step S2610, the method comprises acquiring a signal from a video source configured for outputting video data over a first interface of the network, the video data including native video data having a first frame rate and the signal indicating that the video source has been switched on.

Then, in step S2620, the method comprises acquiring first free running timing signals from the video source.

In step S2630, the method comprises producing a first video signal to be displayed at a second frame rate using the first free running timing signals received from the video source, the first video signal to be displayed comprising initial image data for display before native video data is acquired from the video source. Then, the method proceeds to step S2640.

In step S2640, the method comprises acquiring first native video data from the video source over the first interface, the first native video data from the video source being subject to a frame buffer by the video source.

In step S2650, the method comprises producing a second video signal to be displayed at the second frame rate using the free running timing signals received from the video source, the second video signal to be displayed comprising the first native video data acquired from the video source.

Then, in step S2660, the method comprises acquiring second native video data from the video source over the first interface, the second native video data from the video source not being subject to a frame buffer by the video source.

In step S2670, the method comprises generating second free running timing signals when the signal from the video source is received. The method then proceeds to step S2680.

In step S2680, the method comprises producing a third video signal to be displayed at a third frame rate using the second free running timing signals which have been generated, the third video signal to be displayed comprising the second native video data acquired from the video source.

Step S2690 comprises generating second timing signals after the signal from the video source is received, the second timing signals being adjusted to lock with timing signals of the video source such that a frame rate of the receiver synchronises with the first frame rate of the video source.

Finally, step S2612 comprises producing a fourth video signal to be displayed at the first frame rate using the second timing signals, the fourth video signal to be displayed comprising the second native video data received from the video source.

The method then proceeds to, and ends with, step S2615.

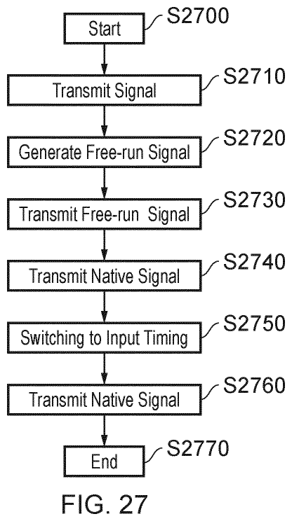

Furthermore, more generally, a method of a transmitting device of a system for distributing data over a network is provided in accordance with embodiments of the disclosure. An example of the method is illustrated in FIG. 27 of the present disclosure.

The method starts at step S2700 and proceeds to step S2710.

In step S2710, the method comprises transmitting a signal to a receiving device indicating that the video source has been switched on. The method then proceeds to step S2720.

In step S2720, the method comprises generating first free running timing signals.

Then, in step S2730, the method comprises transmitting the first free running timing signals to the receiving device.

Once the first free running timing signals have been transmitted, the method proceeds to step S2740.

Step S2740 comprises transmitting native video data of the video source to the receiving device, the native video data being subject to a frame buffer and having a first frame rate established by the first free running timing signals.

Then, in step S2750, the method comprises switching to input timing signals of the video source.

Finally, in step S2760, the method comprises transmitting native video data to the receiving device, the native video data not being subject to a frame buffer and having a second frame rate established by the input timing signals of the video source.

The method then proceeds to, and ends with, step S2770.

It will be appreciated that the methods illustrated in FIGS. 26 and 27 of the present disclosure are not particularly limited to the order and sequence of steps as illustrated in the respective Figures. That is, while the methods may, in some examples, be performed sequentially in the order illustrated, they may, alternatively, be performed in an order different than that illustrated. In particular, a number of the respective steps of the method may be performed in parallel. Nevertheless, the example methods of FIGS. 26 and 27 provide for responsive low latency display of video following the starting-up of a video source in a system for distributing video data over a network.

Example Hardware Configuration

FIG. 28 is an explanatory diagram illustrating an example of a hardware configuration of an apparatus (or device) according to the present embodiment. The apparatus 100 includes, for example, an MPU 150, a ROM 152, a RAM 154, a recording medium 156, an input/output interface 158, an operation input device 160, a display device 162 and a communication interface 164. Further, the apparatus 100, for example, connects respective components with a bus 166 which is a data transmission path.

The MPU 150 is configured with, for example, one or more processors configured with an arithmetic circuit such as an MPU, various kinds of processing circuits, or the like, and functions as a control unit (not illustrated) which controls the whole apparatus 100. Further, the MPU 150 plays a role of, for example, a processing unit 110 in the apparatus 100. Note that the processing unit 110 may be configured with a dedicated (or general-purpose) circuit (such as, for example, a processor separate from the MPU 150) which can implement processing at the processing unit 110.

The ROM 152 stores control data such as a program and an operation parameter to be used by the MPU 150. The RAM 154 temporarily stores a program, or the like, to be executed by the MPU 150.

The recording medium 156, which functions as a storage unit (not illustrated), for example, stores data associated with the methods according to embodiments of the disclosure, and various kinds of data such as various kinds of applications. Here, examples of the recording medium 156 can include, for example, a magnetic recording medium such as a hard disk, and a non-volatile memory such as a flash memory.

Further, the recording medium 156 may be detachable from the apparatus 100. The input/output interface 158, for example, connects the operation input device 160 and the display device 162. The operation input device 160 functions as an operation unit (not illustrated), and the display device 162 functions as a display unit (not illustrated). Here, examples of the input/output interface 158 can include, for example, a universal serial bus (USB) terminal, a digital visual interface (DVI) terminal, a high-definition multimedia interface (HDMI) (registered trademark) terminal, various kinds of processing circuits, or the like.

Further, the operation input device 160 is, for example, provided on the apparatus 100 and is connected to the input/output interface 158 inside the apparatus 100. Examples of the operation input device 160 can include, for example, a button, a direction key, a rotary selector such as a jog dial, combination thereof, or the like.

Further, the display device 162 is, for example, provided on the apparatus 100 and is connected to the input/output interface 158 inside the apparatus 100. Examples of the display device 162 can include, for example, a liquid crystal display, an organic electro-luminescence (EL) display, an organic light emitting diode (OLED) display, or the like. Note that the input/output interface 158 can be connected to an external device such as an external operation input device (such as, for example, a keyboard and a mouse) and an external display device of the apparatus 100. Further, the display device 162 may be a device such as, for example, a touch panel, which can perform display and allows user manipulation.

The communication interface 164 is communication means provided at the apparatus 100. The communication interface 164, for example, functions as a communication unit (not illustrated) for performing communication in a wireless or wired manner with each of one or more external apparatuses, such as the input source apparatus 200, the output destination apparatus 300, the apparatus 400, the display target apparatus 500 and other apparatuses 600A and 600B, as described with reference to FIG. 1 of the present disclosure, via a network (or directly). Further, the communication interface 164 may, for example, play a role of performing communication in a wireless or wired manner with an external apparatus such as a server.

Here, examples of the communication interface 164 can include, for example, a communication antenna and a radio frequency (RF) circuit (wireless communication), an IEEE802.15.1 port and a transmission/reception circuit (wireless communication), an IEEE802.11 port and a transmission/reception circuit (wireless communication), a local area network (LAN) terminal and a transmission/reception circuit (wired communication), or the like.

The apparatus 100 performs processing associated with the methods according to the present disclosure, for example, with the configuration illustrated in FIG. 28 of the present disclosure. Note that the hardware configuration of the medical control apparatus according to the present embodiment is not limited to the configuration illustrated in FIG. 28 of the present disclosure.

For example, in the case where the apparatus 100 performs communication with external apparatuses, or the like, via a connected external communication device, the communication interface 164 does not have to be provided. Further, the communication interface 164 may be configured to enable communication with one or more external apparatuses using a plurality of communication schemes.

Further, the apparatus 100 can, for example, employ a configuration which does not include one or more of the recording medium 156, the operation input device 160 and the display device 162.

Further, for example, part or the whole of the configuration illustrated in FIG. 28 of the present disclosure (or the configuration according to the modified examples) may be implemented with one or more integrated circuits (ICs).

Further, the above-described control processing units are processing divided from the processing associated with the methods according to the present embodiment for convenience sake and efficiency of description. Therefore, the configuration for implementing the processing associated with the control method according to the present embodiment is not limited to the configuration illustrated in FIG. 28 of the present disclosure and can be a configuration in accordance with a way of dividing the processing associated with the methods according to the present embodiment.

While the apparatus has been described above as the present embodiment, the present embodiment is not limited to such an embodiment. The present embodiment can be applied to various kinds of equipment such as, for example, a computer such as a PC, a server and an OR Controller, a tablet type apparatus and a communication apparatus such as a smartphone, which can perform the processing associated with the methods according to the present embodiment. Further, the present embodiment can be applied to, for example, a processing IC which can be incorporated into the equipment as described above.

Furthermore, by a program for causing a computer to function as the apparatus according to the present embodiment (a program which can execute the processing associated with the method according to the present embodiment such as, for example, the above-described control processing) being executed by a processor, or the like, at the computer, it is possible to provide for responsive low latency display of video following the starting-up or switching of a video source or transmitting device in a system for distributing video data over a network.

Further, by a program for causing a computer to function as the apparatus according to the present embodiment being executed by a processor, or the like, at the computer, it is possible to provide effects provided through the above-described processing.

Furthermore, embodiments of the present disclosure may be configured in accordance with the following numbered clauses:
1. Apparatus for a receiving device of a system for distributing video data over a network, the apparatus comprising circuitry configured to:
acquire a signal from a video source configured for outputting video data over a first interface of the network, the video data including native video data having a first frame rate and the signal indicating that the video source has been switched on;
generate free running timing signals when the signal from the video source is acquired; produce a first video signal to be displayed at a second frame rate using the free running timing signals which have been generated, the first video signal to be displayed comprising initial image data for display before native video data is acquired from the video source;
acquire native video data from the video source over the first interface;
produce a second video signal to be displayed at the second frame rate using the free running timing signals which have been generated, the second video signal to be displayed comprising the native video data acquired from the video source;
generate second timing signals after the signal from the first video source is acquired, the second timing signals being adjusted to lock with timing signals of the video source such that a frame rate of the receiving device synchronises with the first frame rate of the first video source; and
produce a third video signal to be displayed at the first frame rate using the second timing signals, the third video signal to be displayed comprising the native video data acquired from the video source.
2. The apparatus according to Clause 1, wherein the circuitry is further configured to acquire image data of an animation as the initial image data for the first video signal.
3. The apparatus according to Clause 1 or 2, wherein the circuitry is further configured to acquire proxy image data as the initial image data for the first video signal, the proxy image data having a same image target as the native video data and one or more different image properties.
4. The apparatus according to Clause 3, wherein the proxy image data is a lower resolution version of the native video data.
5. The apparatus according to Clause 3 or 4, wherein the proxy image data is acquired over the first interface of the network from the video source.
6. The apparatus according to any preceding Clause, wherein the free running timing signals are a free running clock generated by the apparatus and/or the second timing signals are a video clock generated by the video source.
7. The apparatus according to any preceding Clause, wherein the processing circuitry is configured to generate a display signal to display the third video signal when the native video signal is acquired.
8. The apparatus according to any preceding Clause, wherein the processing circuitry is configured to generate a display signal to display the third video signal a predetermined time after the native video signal is acquired.
9. The apparatus according to any preceding Clause, wherein the predetermined time is a time when the second timing signals are locked to the frequency of the timing signals of the video source; or wherein the predetermined time is a time when the second timing signals are locked to the frequency and phase of the timing signals of the video source.
10. Apparatus for a receiving device of a system for distributing video data over a network, the apparatus comprising circuitry configured to:
acquire a signal from a video source configured for outputting video data over a first interface of the network, the video data including native video data having a first frame rate and the signal indicating that the video source has been switched on;
acquire first free running timing signals from the video source;
produce a first video signal to be displayed at a second frame rate using the first free running timing signals received from the video source, the first video signal to be displayed comprising initial image data for display before native video data is acquired from the video source;
acquire first native video data from the video source over the first interface, the first native video data from the video source being subject to a frame buffer by the video source;
produce a second video signal to be displayed at the second frame rate using the free running timing signals received from the video source, the second video signal to be displayed comprising the first native video data acquired from the video source;
acquire second native video data from the video source over the first interface, the second native video data from the video source not being subject to a frame buffer by the video source;
generate second free running timing signals when the signal from the video source is received;
produce a third video signal to be displayed at a third frame rate using the second free running timing signals which have been generated, the third video signal to be displayed comprising the second native video data acquired from the video source;
generate second timing signals after the signal from the video source is received, the second timing signals being adjusted to lock with timing signals of the video source such that a frame rate of the receiver synchronises with the first frame rate of the video source; and
produce a fourth video signal to be displayed at the first frame rate using the second timing signals, the fourth video signal to be displayed comprising the second native video data received from the video source.
11. Apparatus for a video source of a system for distributing data over a network, the apparatus comprising circuitry configured to:
transmit a signal to a receiving device indicating that the video source has been switched on;
generate first free running timing signals;
transmit the first free running timing signals to the receiving device;
transmit native video data of the video source to the receiving device, the native video data being subject to a frame buffer and having a first frame rate established by the first free running timing signals;
switch to input timing signals of the video source;
transmit native video data to the receiving device the native video data not being subject to a frame buffer and having a second frame rate established by the input timing signals of the video source.
12. Method for a receiver side of a system for distributing video data over a network, the method comprising the steps of:
acquiring a signal from a video source configured for outputting video data over a first interface of the network, the video data including native video data having a first frame rate and the signal indicating that the video source has been switched on;
generating free running timing signals when the signal from the video source is acquired;
producing a first video signal to be displayed at a second frame rate using the free running timing signals which have been generated, the first video signal to be displayed comprising initial image data for display before native video data is acquired from the video source;
acquiring native video data from the video source over the first interface;
producing a second video signal to be displayed at the second frame rate using the free running timing signals which have been generated, the second video signal to be displayed comprising the native video data acquired from the video source;
generating second timing signals after the signal from the first video source is acquired, the second timing signals being adjusted to lock with timing signals of the video source such that a frame rate of the receiving device synchronises with the first frame rate of the first video source; and
producing a third video signal to be displayed at the first frame rate using the second timing signals, the third video signal to be displayed comprising the native video data acquired from the video source.
13. Method for a receiver side of a system for distributing video data over a network, the method comprising the steps of:
acquiring a signal from a video source configured for outputting video data over a first interface of the network, the video data including native video data having a first frame rate and the signal indicating that the video source has been switched on;
acquiring first free running timing signals from the video source;
producing a first video signal to be displayed at a second frame rate using the first free running timing signals received from the video source, the first video signal to be displayed comprising initial image data for display before native video data is acquired from the video source;
acquiring first native video data from the video source over the first interface, the first native video data from the video source being subject to a frame buffer by the video source;
producing a second video signal to be displayed at the second frame rate using the free running timing signals received from the video source, the second video signal to be displayed comprising the first native video data acquired from the video source;
acquiring second native video data from the video source over the first interface, the second native video data from the video source not being subject to a frame buffer by the video source;
generating second free running timing signals when the signal from the video source is received; producing a third video signal to be displayed at a third frame rate using the second free running timing signals which have been generated, the third video signal to be displayed comprising the second native video data acquired from the video source;
generating second timing signals after the signal from the video source is received, the second timing signals being adjusted to lock with timing signals of the video source such that a frame rate of the receiver synchronises with the first frame rate of the video source; and
producing a fourth video signal to be displayed at the first frame rate using the second timing signals, the fourth video signal to be displayed comprising the second native video data received from the video source.
14. Method of a video source side in a system for distributing data over a network, the method comprising the steps of:
transmitting a signal to a receiving device indicating that the video source has been switched on;
generating first free running timing signals;
transmitting the first free running timing signals to the receiving device;
transmitting native video data of the video source to the receiving device, the native video data being subject to a frame buffer and having a first frame rate established by the first free running timing signals;
switching to input timing signals of the video source;
transmitting native video data to the receiving device the native video data not being subject to a frame buffer and having a second frame rate established by the input timing signals of the video source.
15. Apparatus for a receiving device of a system for distributing video data over a network, the apparatus comprising circuitry configured to:
produce a first video signal to be displayed at a first frame rate using first timing signals, the first video signal to be displayed comprising native video data acquired from a first video source;
acquire a signal from a second video source configured for outputting initial image data and second native video data over the network, the second native video data having a second frame rate and the signal indicating a switch to produce a video signal to be displayed using the second native video data from the second video source, wherein the initial image data comprises image data to be displayed before the native video data from the second video source is displayed;
produce a second video signal to be displayed at a second frame rate, the second video signal to be displayed comprising initial image data acquired from the second video source;
generate free running timing signals after the signal from the second video source is acquired, the free running timing signals being adjusted to lock with timing signals of the second video source such that a frame rate of the receiving device synchronises with the frame rate of the second video source; and
produce a third video signal to be displayed at the frame rate of the second video source using the free running timing signals, the third video signal to be displayed comprising native video data acquired from the second video source.
16. The apparatus according to Clause 15, wherein the circuitry is further configured to acquire image data of an animation as the initial image data from the second video source.
17. The apparatus according to Clause 15, wherein the circuitry is further configured to acquire proxy image data as the initial image data from the second video source, the proxy image data having a same image target as the second native video data and one or more different image properties.
18. The apparatus according to Clause 17, wherein the proxy image data is a lower resolution version of the native video data.
19. The apparatus according to any of Clauses 15 to 18, wherein the free running timing signals are a free running clock generated by the apparatus and/or the timing signals of the second video source are a video clock generated by the second video source.
20. The apparatus according to any of Clauses 15 to 19, wherein the third video signal is produced when the free running video clock has been adjusted to lock with the timing signals of the second video source.
21. The apparatus according to Clauses 15 to 20, wherein the circuitry is configured to generate a display signal to display the third video signal a predetermined time after the native video signal is acquired.
22. The apparatus according to Clause 21, wherein the predetermined time is a time when the free running timing signals are locked to the frequency of the timing signals of the video source; or wherein the predetermined time is a time when the free running timing signals are locked to the frequency and phase of the timing signals of the video source.
23. Method for a receiver side of a system for distributing video data over a network, the method comprising the steps of:
producing a first video signal to be displayed at a first frame rate using first timing signals, the first video signal to be displayed comprising native video data acquired from a first video source;
acquiring a signal from a second video source configured for outputting initial image data and second native video data over the network, the second native video data having a second frame rate and the signal indicating a switch to produce a video signal to be displayed using the second native video data from the second video source, wherein the initial image data comprises image data to be displayed before the native video data from the second video source is displayed;
producing a second video signal to be displayed at a second frame rate, the second video signal to be displayed comprising initial image data acquired from the second video source;
generating free running timing signals after the signal from the second video source is acquired, the free running timing signals being adjusted to lock with timing signals of the second video source such that a frame rate of the receiving device synchronises with the frame rate of the second video source; and
producing a third video signal to be displayed at the frame rate of the second video source using the free running timing signals, the third video signal to be displayed comprising native video data acquired from the second video source.
24. Computer program product comprising instructions which, when the program is implemented by the computer, cause the computer to perform a method of any of Clauses 12, 13, 14 or 23.

While a number of examples of the present disclosure have been described with reference to the use of medical imaging devices (such as medical endoscopes) the present disclosure is not particularly limited in this regard. Tat is, the problems related to the display of low latency video when starting up or switching video sources as described in this disclosure apply also to the use of other video sources in other example situations (such as cameras, scanners, industrial endoscopes or the like).

Furthermore, while certain example timing charts have been used in order to illustrate certain examples of the disclosure, it will be appreciated that the present disclosure is not particularly to the specific order and timing described in these examples. That is, the timing illustrated in these examples is only illustrative and is not limiting to the present disclosure.

In fact, while certain examples of the present disclosure have been discussed with reference to an IP network and IP streaming, it will be appreciated that this is only one such example of a system for distributing video data over a network. More generally, the embodiments of the disclosure can be applied to any such system for distributing video data over a network, and are not limited to IP networks and IP streaming at all.

Obviously, numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. Apparatus for a receiving device of a system for distributing video data over a network, the apparatus comprising circuitry configured to:
acquire a signal from a video source configured for outputting video data over a first interface of the network, the video data including native video data having a first frame rate and the signal indicating that the video source has been switched on;
generate free running timing signals when the signal from the video source is acquired;
produce a first video signal to be displayed at a second frame rate using the free running timing signals which have been generated, the first video signal to be displayed comprising initial image data for display before native video data is acquired from the video source;
acquire native video data from the video source over the first interface;
produce a second video signal to be displayed at the second frame rate using the free running timing signals which have been generated, the second video signal to be displayed comprising the native video data acquired from the video source;
generate second timing signals after the signal from the first video source is acquired, the second timing signals being adjusted to lock with timing signals of the video source such that a frame rate of the receiving device synchronises with the first frame rate of the first video source; and
produce a third video signal to be displayed at the first frame rate using the second timing signals, the third video signal to be displayed comprising the native video data acquired from the video source.

2. The apparatus according to claim 1, wherein the circuitry is further configured to acquire image data of an animation as the initial image data for the first video signal.

3. The apparatus according to claim 1, wherein the circuitry is further configured to acquire proxy image data as the initial image data for the first video signal, the proxy image data having a same image target as the native video data and one or more different image properties.

4. The apparatus according to claim 3, wherein the proxy image data is a lower resolution version of the native video data.

5. The apparatus according to claim 3, wherein the proxy image data is acquired over the first interface of the network from the video source.

6. The apparatus according to claim 1, wherein the free running timing signals are a free running clock generated by the apparatus and/or the second timing signals are a video clock generated by the video source.

7. The apparatus according to claim 1, wherein the circuitry is configured to generate a display signal to display the third video signal when the native video signal is acquired.

8. The apparatus according to claim 1, wherein the circuitry is configured to generate a display signal to display the third video signal a predetermined time after the native video signal is acquired.

9. The apparatus according to claim 8, wherein the predetermined time is a time when the second timing signals are locked to the frequency of the timing signals of the video source; or wherein the predetermined time is a time when the second timing signals are locked to the frequency and phase of the timing signals of the video source.

10. Apparatus for a receiving device of a system for distributing video data over a network, the apparatus comprising circuitry configured to:
acquire a signal from a video source configured for outputting video data over a first interface of the network, the video data including native video data having a first frame rate and the signal indicating that the video source has been switched on;
acquire first free running timing signals from the video source;
produce a first video signal to be displayed at a second frame rate using the first free running timing signals received from the video source, the first video signal to be displayed comprising initial image data for display before native video data is acquired from the video source;
acquire first native video data from the video source over the first interface, the first native video data from the video source being subject to a frame buffer by the video source;
produce a second video signal to be displayed at the second frame rate using the free running timing signals received from the video source, the second video signal to be displayed comprising the first native video data acquired from the video source;
acquire second native video data from the video source over the first interface, the second native video data from the video source not being subject to a frame buffer by the video source;
generate second free running timing signals when the signal from the video source is received;
produce a third video signal to be displayed at a third frame rate using the second free running timing signals which have been generated, the third video signal to be displayed comprising the second native video data acquired from the video source;
generate second timing signals after the signal from the video source is received, the second timing signals being adjusted to lock with timing signals of the video source such that a frame rate of the receiver synchronises with the first frame rate of the video source; and
produce a fourth video signal to be displayed at the first frame rate using the second timing signals, the fourth video signal to be displayed comprising the second native video data received from the video source.

11. Apparatus for a video source of a system for distributing data over a network, the apparatus comprising circuitry configured to:
transmit a signal to a receiving device indicating that the video source has been switched on;
generate first free running timing signals;
transmit the first free running timing signals to the receiving device;
transmit native video data of the video source to the receiving device, the native video data being subject to a frame buffer and having a first frame rate established by the first free running timing signals;
switch to input timing signals of the video source;
transmit native video data to the receiving device the native video data not being subject to a frame buffer and having a second frame rate established by the input timing signals of the video source.

12. Method for a receiver side of a system for distributing video data over a network, the method comprising the steps of:
acquiring a signal from a video source configured for outputting video data over a first interface of the network, the video data including native video data having a first frame rate and the signal indicating that the video source has been switched on;
generating free running timing signals when the signal from the video source is acquired;
producing a first video signal to be displayed at a second frame rate using the free running timing signals which have been generated, the first video signal to be displayed comprising initial image data for display before native video data is acquired from the video source;
acquiring native video data from the video source over the first interface;
producing a second video signal to be displayed at the second frame rate using the free running timing signals which have been generated, the second video signal to be displayed comprising the native video data acquired from the video source;
generating second timing signals after the signal from the first video source is acquired, the second timing signals being adjusted to lock with timing signals of the video source such that a frame rate of the receiving device synchronises with the first frame rate of the first video source; and
producing a third video signal to be displayed at the first frame rate using the second timing signals, the third video signal to be displayed comprising the native video data acquired from the video source.

13. Method for a receiver side of a system for distributing video data over a network, the method comprising the steps of:
acquiring a signal from a video source configured for outputting video data over a first interface of the network, the video data including native video data having a first frame rate and the signal indicating that the video source has been switched on;
acquiring first free running timing signals from the video source;
producing a first video signal to be displayed at a second frame rate using the first free running timing signals received from the video source, the first video signal to be displayed comprising initial image data for display before native video data is acquired from the video source;
acquiring first native video data from the video source over the first interface, the first native video data from the video source being subject to a frame buffer by the video source;
producing a second video signal to be displayed at the second frame rate using the free running timing signals received from the video source, the second video signal to be displayed comprising the first native video data acquired from the video source;
acquiring second native video data from the video source over the first interface, the second native video data from the video source not being subject to a frame buffer by the video source;
generating second free running timing signals when the signal from the video source is received;
producing a third video signal to be displayed at a third frame rate using the second free running timing signals which have been generated, the third video signal to be displayed comprising the second native video data acquired from the video source;
generating second timing signals after the signal from the video source is received, the second timing signals being adjusted to lock with timing signals of the video source such that a frame rate of the receiver synchronises with the first frame rate of the video source; and
producing a fourth video signal to be displayed at the first frame rate using the second timing signals, the fourth video signal to be displayed comprising the second native video data received from the video source.

14. Method of a video source side in a system for distributing data over a network, the method comprising the steps of:
transmitting a signal to a receiving device indicating that the video source has been switched on;
generating first free running timing signals;
transmitting the first free running timing signals to the receiving device;
transmitting native video data of the video source to the receiving device, the native video data being subject to a frame buffer and having a first frame rate established by the first free running timing signals;
switching to input timing signals of the video source;
transmitting native video data to the receiving device the native video data not being subject to a frame buffer and having a second frame rate established by the input timing signals of the video source.

15. Apparatus for a receiving device of a system for distributing video data over a network, the apparatus comprising circuitry configured to:
produce a first video signal to be displayed at a first frame rate using first timing signals, the first video signal to be displayed comprising native video data acquired from a first video source;
acquire a signal from a second video source configured for outputting initial image data and second native video data over the network, the second native video data having a second frame rate and the signal indicating a switch to produce a video signal to be displayed using the second native video data from the second video source, wherein the initial image data comprises image data to be displayed before the native video data from the second video source is displayed;
produce a second video signal to be displayed at a second frame rate, the second video signal to be displayed comprising initial image data acquired from the second video source;
generate free running timing signals after the signal from the second video source is acquired, the free running timing signals being adjusted to lock with timing signals of the second video source such that a frame rate of the receiving device synchronises with the frame rate of the second video source; and
produce a third video signal to be displayed at the frame rate of the second video source using the free running timing signals, the third video signal to be displayed comprising native video data acquired from the second video source.

16. The apparatus according to claim 15, wherein the circuitry is further configured to acquire image data of an animation as the initial image data from the second video source.

17. The apparatus according to claim 15, wherein the circuitry is further configured to acquire proxy image data as the initial image data from the second video source, the proxy image data having a same image target as the second native video data and one or more different image properties.

18. The apparatus according to claim 17, wherein the proxy image data is a lower resolution version of the native video data.

19. The apparatus according to claim 15, wherein the free running timing signals are a free running clock generated by the apparatus and/or the timing signals of the second video source are a video clock generated by the second video source.

20. The apparatus according to claim 15, wherein the third video signal is produced when the free running video clock has been adjusted to lock with the timing signals of the second video source.

21.-24. (canceled)
